(19) United States
(12) Patent Application Publication
(10) Pub. No.: US 2026/0039731 A1
(43) Pub. Date: Feb. 5, 2026

(54) METHODS AND APPARATUS FOR HANDLING PDUS TO ACHIEVE TARGET PDU SET ERROR RATE IN TRANSMISSION

(71) Applicant: Huawei Technologies Co., Ltd., Shenzhen (CN)

(72) Inventor: Yunsong Yang, San Diego, CA (US)

(21) Appl. No.: 19/300,445

(22) Filed: Aug. 14, 2025

Related U.S. Application Data
(63) Continuation of application No. PCT/US2024/013082, filed on Jan. 26, 2024.
(60) Provisional application No. 63/485,173, filed on Feb. 15, 2023.

(51) Int. Cl. H04L 69/322; H04W 36/00

(52) U.S. Cl. CPC H04L 69/322; H04W 36/0055

(57) ABSTRACT

According to embodiments, an apparatus obtains a protocol data unit (PDU) of a data stream. The apparatus determines whether the PDU satisfies one or more conditions. The apparatus transmits the PDU in accordance with a first manner in response to determining that the PDU satisfies the one or more conditions, or in accordance with a second manner in response to determining that the PDU does not satisfy the one or more conditions. The second manner is different from the first manner in which one or more bearers among established multiple bearers are utilized in transmitting the PDU.

### CROSS-REFERENCE TO RELATED APPLICATIONS

This application is a continuation of International Application No. PCT/US2024/013082, filed on Jan. 26, 2024 and entitled “Methods and Apparatus for Handling PDUs to Achieve Target PDU Set Error Rate in Transmission,” which claims priority to U.S. Provisional Patent Application No. 63/485,173, filed on Feb. 15, 2023 and entitled “Methods and Apparatus for Handling PDUs to Achieve Target PDU Set Error Rate in Transmission,” applications of which are incorporated herein by reference in their entireties.

### TECHNICAL FIELD

The present disclosure relates generally to wireless communications, and, in particular embodiments, to methods and apparatus for PDUs handling.

### BACKGROUND

Some network traffic has a stringent latency requirement. Such traffic includes, but is not limited to, traffic for extended reality (XR). XR is a term covering augmented reality (AR), virtual reality (VR), mixed reality (MR), and the like. XR is expected to be an important driving force for developing the next generation wireless communication technologies, due to its requirements for high data throughputs, high system capacity, high reliability, and low latency.

The downlink (DL) XR traffic, i.e., the data traffic from an XR server (which is typically located in the cloud or edge cloud) to an XR client (which is typically located inside a user equipment (UE)), usually includes an audio stream, a video stream, and one or more additional data streams (e.g., for haptic feedback). The uplink (UL) XR traffic, i.e., the data traffic from the XR client to the XR server, usually includes an audio stream and one or more additional data streams (e.g., for sensing/pose data). In AR applications, the UL XR traffic further includes a video stream. Each of these concurrent data streams includes periodic packets or periodic bursts of packets, with each stream having different periodicities and different delay requirements. For example, for an audio stream, an audio packet may be generated once every 10 milliseconds (msec) and may have a delay budget of about 30 msec, and for a pose stream, a pose packet may be generated once every 2.5 msec and may have a delay budget of about 10 msec. The periodicity of the data bursts in a video stream depends on the frame refresh rate, or more specifically, is the inverse of the frame refresh rate. For example, the data burst periodicity is 16.666 msec for a video stream with a constant frame refresh rate of 60 frames per second (FPS). For VR applications, the DL video packets usually have a delay budget of about 10 msec. For AR applications, the UL video packets usually have a delay budget of about 30 msec.

Data produced by audio applications or sensing/pose applications tend to have a small size, e.g., a size of one hundred to a few hundreds of bytes, and therefore can be transported using a single packet over most upper layer protocols, e.g., a real time protocol (RTP) packet over the RTP layer or an internet protocol (IP) packet over the IP layer, etc. On the other hand, a data burst in an XR video stream usually includes a variable number of packets together carrying a payload corresponding to a video frame, the number of packets varying from burst to burst, depending on not only the graphic content in the video frame but also whether inter-frame compression is used in encoding the data of the video frame.

### SUMMARY

Technical advantages are generally achieved, by embodiments of this disclosure which describe methods and apparatus.

According to embodiments, an apparatus establishes multiple bearers to be used for transmitting protocol data units (PDUs) of a data stream. The apparatus obtains a PDU of the data stream. The apparatus determines whether the PDU satisfies one or more conditions. The apparatus transmits the PDU in accordance with a first manner in response to determining that the PDU satisfies the one or more conditions, or in accordance with a second manner in response to determining that the PDU does not satisfy the one or more conditions. The second manner is different from the first manner in which one or more bearers among established multiple bearers are utilized in transmitting the PDU.

In some embodiments, the apparatus may classify the PDU as a first type or a second type based on a result of the determining whether the PDU satisfies the one or more conditions, the first type corresponding to satisfying the one or more conditions, and the second type corresponding to not satisfying the one or more conditions. Transmitting the PDU in accordance with the first manner may be in response to classifying the PDU as the first type. Transmitting the PDU in accordance with the second manner may be in response to classifying the PDU as the second type.

In some embodiments, the apparatus may be or may be part of a user equipment (UE). The UE may obtain the PDU from an upper layer of the UE. The UE may transmit the PDU to a base station serving the UE.

In some embodiments, the apparatus may be or may be part of a base station. The base station may receive the PDU from a core network node. The base station may transmit the PDU to a UE served by the base station.

In some embodiments, the apparatus may obtain configuration about the one or more conditions associated with the PDUs of the data stream. The apparatus may determine whether the PDU satisfies the one or more conditions in accordance with the configuration.

In some embodiments, the configuration may indicate a PDU Set size threshold. The apparatus may obtain a total number of all PDUs in a PDU Set that the PDU belongs to. The apparatus may determine that the PDU satisfies the one or more conditions in response to the total number being greater than the PDU Set size threshold or determine that the PDU does not satisfy the one or more conditions in response to the total number being less than the PDU Set size threshold.

In some embodiments, the configuration may indicate at least a first set of PDU Set importance values and a second set of PDU Set importance values. The first set of PDU Set importance values may correspond to satisfying the one or more conditions. The second set of PDU Set importance values may correspond to not satisfying the one or more conditions. The apparatus may obtain a PDU Set importance value of the PDU Set that the PDU belongs to. The apparatus may determine that the PDU satisfies the one or more conditions in response to the PDU Set importance value being among the first set of PDU Set importance values or determine that the PDU does not satisfy the one or more conditions in response to the PDU Set importance value being among the second set of PDU Set importance values.

In some embodiments, the configuration may indicate a time threshold. The apparatus may obtain a remaining time until a delivery deadline associated with the PDU. The apparatus may determine that the PDU satisfies the one or more conditions in response to the remaining time being less than the time threshold or determine that the PDU does not satisfy the one or more conditions in response to the remaining time being greater than the time threshold.

In some embodiments, the configuration may indicate at least a first set of media data unit (MDU) type values and a second set of MDU type values. The first set of MDU type values may correspond to satisfying the one or more conditions. The second set of MDU type values may correspond to not satisfying the one or more conditions. The apparatus may obtain an MDU type value of an MDU carried by the PDU Set that the PDU belongs to. The apparatus may determine that the PDU satisfies the one or more conditions in response to the MDU type value being among the first set of MDU type values or determine that the PDU does not satisfy the one or more conditions in response to the MDU type value being among the second set of MDU type values.

In some embodiments, the configuration may indicate at least a first set of inter-dependency indication values and a second set of inter-dependency indication values. The first set of inter-dependency indication values may correspond to satisfying the one or more conditions. The second set of inter-dependency indication values may correspond to not satisfying the one or more conditions. The apparatus may obtain an inter-dependency indication value of the PDU Set that the PDU belongs to. The apparatus may determine that the PDU satisfies the one or more conditions in response to the inter-dependency indication value being among the first set of inter-dependency indication values or determine that the PDU does not satisfy the one or more conditions in response to the inter-dependency indication value being among the second set of inter-dependency indication values.

In some embodiments, the configuration may indicate at least a first set of discardable indication values and a second set of discardable indication values. The first set of discardable indication values may correspond to satisfying the one or more conditions. The second set of discardable indication values may correspond to not satisfying the one or more conditions. The apparatus may obtain a discardable indication value of the PDU Set that the PDU belongs to. The apparatus may determine that the PDU satisfies the one or more conditions in response to the discardable indication value among the first set of discardable indication values or determine that the PDU does not satisfy the one or more conditions in response to the discardable indication value being among the second set of discardable indication values.

In some embodiments, the established multiple bearers may be multiple radio link control (RLC) bearers. Determining whether the PDU satisfies the one or more conditions may be performed by a packet data convergence protocol (PDCP) entity of the apparatus.

In some embodiments, the apparatus may transmit in the first manner by submitting the PDU to a first RLC entity configured for a first RLC bearer among the multiple RLC bearers. The apparatus may transmit in the second manner by submitting the PDU to a second RLC entity configured for a second RLC bearer among the multiple RLC bearers. The first RLC bearer may be configured to be more reliable than the second RLC bearer.

In some embodiments, the first RLC entity may be configured to operate in an RLC acknowledged mode (AM). The second RLC entity is configured to operate in an RLC unacknowledged mode (UM).

In some embodiments, the first RLC entity may be configured to operate in an RLC AM with a third number of RLC retransmissions maximally allowed. The second RLC entity may be configured to operate in the RLC AM with a fourth number of RLC retransmissions maximally allowed. The third number may be greater than the fourth number.

In some embodiments, the apparatus may configure a media access control (MAC) entity of the apparatus with a restriction. The MAC entity may be associated with the first RLC bearer. The restriction may prohibit the MAC entity from assigning a transmission opportunity to a logical channel associated with the first RLC bearer. The transmission opportunity may utilize an unlicensed band.

In some embodiments, the apparatus may transmit in the first manner by submitting the PDU to a first number of RLC entities respectively configured for a first number of RLC bearers among the multiple RLC bearers. The apparatus may transmit in the second manner by submitting the PDU to a second number of RLC entities respectively configured for a second number of RLC bearers among the multiple RLC bearers. The first number may be greater than the second number.

In some embodiments, the apparatus may transmit in the first manner by using PDCP duplication to duplicate the PDU for the submitting to the first number of RLC bearers. The apparatus may transmit in the second manner by using PDCP duplication to duplicate the PDU for the submitting to the second number of RLC bearers. The second number may be greater than one.

In some embodiments, the established multiple bearers may be multiple data radio bearers (DRBs). Determining whether the PDU satisfies the one or more conditions may be performed by a service data adaptation protocol (SDAP) entity of the apparatus.

In some embodiments, the apparatus may transmit in the first manner by submitting the PDU to a first PDCP entity of the apparatus. The first PDCP entity may be configured for a first DRB among the multiple DRBs. The apparatus may transmit in the second manner by submitting the PDU to a second PDCP entity of the apparatus. The second PDCP entity may be configured for a second DRB among the multiple DRBs. The first DRB may be configured to be more reliable than the second DRB.

In some embodiments, the apparatus may transmit in the first manner by submitting the PDU to a fifth number of PDCP entities of the apparatus. The fifth number of PDCP entities may be respectively configured for a fifth number of DRBs among the multiple DRBs. The apparatus may transmit in the second manner by submitting the PDU to a sixth number of PDCP entities of the apparatus. The sixth number of PDCP entities may be respectively configured for a sixth number of DRBs among the multiple DRBs. The fifth number may be greater than the sixth number.

In some embodiments, the data stream may be a video stream of a same quality of service (QoS) flow.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows an example of enhanced split bearers, according to some embodiments;

FIG. 2 shows an example of enhanced split bearers, according to some embodiments;

FIG. 3 shows an example of enhanced split bearers, according to some embodiments;

FIG. 4 illustrates an example of selective PDCP duplication, according to some embodiments;

FIG. 5 illustrates an example of selective PDCP duplication, according to some embodiments;

FIG. 6 illustrates an example of selective PDCP duplication, according to some embodiments;

FIG. 7 illustrates an example of selective PDCP duplication, according to some embodiments;

FIG. 8A shows the signaling of a configuration with the pduSetSupport field, according to some embodiments;

FIG. 8B shows the signaling of an alternative configuration, according to some embodiments;

FIG. 9A illustrates an example procedure of performing the PDU classification, according to some embodiments;

FIG. 9B illustrates an example procedure of performing the transmission of the PDU with the selective PDCP duplication, according to some embodiments;

FIG. 9C illustrates an example procedure of performing the transmission of the PDU with the dynamic bearer switching, according to some embodiments;

FIG. 10A illustrates an alternative example procedure of performing the transmission of the PDU with the selective PDCP duplication, according to some embodiments;

FIG. 10B illustrates an alternative example procedure of performing the transmission of the PDU with the dynamic bearer switching, according to some embodiments;

FIG. 11 shows an example flow diagram of operations occurring in a UE, according to some embodiments;

FIG. 12 shows an example flow diagram of operations occurring in a base station, according to some embodiments;

FIG. 13 shows a flow chart of a method performed by an apparatus, according to some embodiments;

FIG. 14 illustrates an example communications system, according to embodiments;

FIG. 15 illustrates an example communication system, according to some embodiments;

FIGS. 16A and 16B illustrate example devices that may implement the methods and teachings according to this disclosure; and

FIG. 17 is a block diagram of a computing system that may be used for implementing the devices and methods disclosed herein.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Video encoding is a technique to reduce the data size of video frames and therefore the amount of radio resouces required to transmit the video frames in a wireless communicaiton system, while still maintaining a good quality of experience for the users. Most of today's video transmission systems such as specified within the third generation partnership project (3GPP) make use of H.264/advanced video coding (AVC), which is a video encoding standard featuring block oriented motion compensation and transform coding. Motion compensation is a video compression technique that utilizes inter-frame (i.e., temporal) prediction to reduce redundancy of video data. H.264/AVC coded video frames can be classified into the following set of frame types: intra-coded (I) frames, instantaneous decoder refresh (IDR) frames, predictive-coded (P) frames and bi-predictive-coded (B) frames. I frames do not predict data from surrounding frames and can therefore be decoded independently. IDR frames are I frames that refresh the decoding picture buffer. Therefore, all frames following in coding order do not have access to frames prior to the IDR frame for prediction. P frames use temporally preceding frames for prediction (i.e., to generate the differences between a P frame and a preceding frame that is used as a reference, the differences also being referred to as the prediction errors), whereas B frames use both temporally preceding and following frames for prediction. For I frames, transform coding is applied to the original video image values, while for P frames and B frames, transform coding is applied to the prediction errors. Therefore, data compression ratio (i.e., the total data volume of the raw video frame vs. that of the corresponding encoded frame) achieved on P frames and B frames tend to be much higher than that on I frames. For example, within a same video stream, the size of a P frame can be one half to one tenth (with an average of about one quarter) of the size of an I frame, depending on whether the objects in the video are in high-speed motion or relatively stationary. Most XR applications require the use of high resolution video, such as 4k video for VR, in order for the end viewers to feel like being inside of a real-world environment. Therefore, the size of both I frames and P frames in an XR video stream usually well exceed the maximal payload size of a packet (e.g., an IP packet) used in the transport network. For example, on average, 80 IP packets may be required to carry the payload of an I frame in a 4k video stream, while that number may be around 20, on average, for P frames in the same video stream, assuming the maximal payload size of the IP packets is 1500 bytes.

The extension for Scalable Video Coding (SVC) in H.264/AVC allows further structuring the bitstream and extracting different video representations of a single bitstream, referred to as layers. The base layer of SVC provides the lowest quality level and is an H.264/AVC compliant bitstream to ensure backward-compatibility with existing receivers. Each additional enhancement layer improves the video quality in a certain dimension. SVC allows up to three different scalability dimensions within one bitstream: temporal, spatial, and quality scalability, which yields great potential to achieve a more efficient and flexible provisioning of video services.

3GPP technical specification group (TSG) radio access network (RAN) is currently working on a work item to enhance 5G NR standards to support XR services better. The concept of protocol data unit (PDU) Set has been introduced, where a PDU Set includes one or more PDUs carrying the payload of one unit of information generated at the application level. Such unit of information is also referred to as an application data unit (ADU) or a media data unit (MDU). Examples of an MDU include a video frame, a slice of a video frame, a base layer of a video frame, and an enhancement layer of a video frame. In some implementations, all PDUs in a PDU Set are needed by the application layer of the recipient to use the corresponding MDU. In other implementations, when some PDUs of a PDU Set are missing, the application layer of the recipient may still be able to recover parts of the MDU, or with concealment techniques, even the entire MDU with certain impairment that may be less noticeable comparing to without using the concealment techniques. The interpretation of a PDU or PDUs may be context specific. For example, when a PDU is referred at the RTP layer, it may refer to an RTP packet, when it is referred at the IP layer, it may refer to an IP packet, and when it is referred at the packet data convergence protocol (PDCP) layer, it may refer to a PDCP service data unit (SDU) or PDCP PDU, etc. Therefore, the interpretation of a PDU Set or PDU Sets may also be context specific. For example, when a PDU Set is referred at the RTP layer, it may refer to a group of RTP packets carrying a same MDU, when it is referred at the IP layer, it may refer to a group of IP packets carrying the same MDU, and when it is referred at the PDCP layer, it may refer to a group of PDCP SDUs or PDCP PDUs carrying the same MDU, etc.

One conventional quality of service (QoS) parameter used for specifying a target error performance of a radio communication link in delivering a data service is the packet error rate (PER), which is usually expressed as a total number of packets in error vs. a total number of packets transmitted within an observation window. However, for video traffic, the quality of experience (QoE) may be measured at the application layer, e.g., as viewed by an end user, based on how often a video frame is in error. On the other hand, as previously explained, the number of packets (also referred to as PDUs) varies from frame to frame in a video stream. Therefore, the conventional PER may no longer be adequate in reflecting the QoE perceived by the user. Instead of using PER, 3GPP has introduced a new QoS parameter, referred to as the PDU Set Error Rate (PSER), for specifying a target error performance measured at the PDU Set level. In 3GPP Technical Report (TR) 23.700-60, PSER is defined as a target upper bound for the rate of PDU Sets that have been processed by the sender of a link layer protocol (e.g., radio link control (RLC) in RAN of a 3GPP access) but where not all of the PDUs in the PDU Set are successfully delivered by the corresponding receiver to the upper layer (e.g., PDCP in RAN of a 3GPP access).

To support XR video traffic on the DL, 3GPP working group (WG) system and architecture 2 (SA2) has concluded that the user plane function (UPF) can be configured by the session management function (SMF) to map all PDUs of a DL XR video stream onto a same QoS flow, by disregarding what type of MDU is carried by a PDU Set that a PDU belongs to, and therefore, to associate a same QoS flow ID (QFI) to each PDU of the XR video stream. The UPF is further configured to provide the QFI value to the gNB along with the each PDU, e.g., by including the QFI value in the general packet radio service (GPRS) tunneling protocol—user plane (GTP-U) extension header of a GTP-U packet sent from the UPF to the gNB, the GTP-U packet carrying the each PDU. In accordance with the current 5G NR standards, when the gNB receives these PDUs, the service data adaptation protocol (SDAP) entity configured for the XR PDU session maps all these PDUs onto a same data radio bearer (DRB) configured for delivering the DL XR video stream. To support XR video traffic on the UL, it is expected that the UE can be similarly configured by the SMF to map all PDUs of an UL XR video stream onto a same QoS flow and thereafter onto a same DRB configured for delivering the UL XR video stream.

In accordance with the current 5G NR standards, QoS requirements are managed on a per QoS flow basis over the transport network in the 5G core (5GC), and on a per radio bearer (RB) basis over the RAN. Within the RAN, all PDUs mapped onto a same RB for transmission will be handled in a same manner because the QoS requirements, which include the target error performance, are considered as being uniform among all the PDUs of the same RB. When neither split bearers nor PDCP duplication is used on a DRB, the DRB is configured with one underlying RLC bearer, which is configured to operate at a target error performance in accordance with the QoS parameter PER. An RLC bearer may also be referred to as an RLC channel. When split bearers or PDCP duplication is configured on a DRB, the DRB is configured with multiple underlying RLC bearers. In the case of the conventional split bearers, each underlying RLC bearer is configured to operate at a same target error performance in accordance with the QoS parameter PER to ensure that the target PER can be met no matter how the PDUs are split among the multiple RLC bearers during their transmissions. In the case of the conventional PDCP duplication, every PDU, after being encoded as a PDCP PDU, is duplicated by the transmitting PDCP entity, which is configured for the DRB, and transmitted via all underlying active RLC bearers to ensure that the target PER can be met with the redundancy provided by the duplicated transmissions, while the same target PER may not be met by any single RLC bearer alone.

With the introduction of PSER, the error performance of a DRB for delivering an XR video stream is measured and managed at the PDU Set level. If any PDU of a PDU Set is not successfully delivered to the recipient, the PDU Set is considered as being lost. As we had described before, the number of packets (PDUs) in each PDU Set of an XR video stream varies from frame to frame, with significant differences existing between frames that use inter-frame compression (e.g., the P frames) and frames that don't (e.g., the I frames). If all PDUs mapped onto a same DRB for transmission continue to be handled in a same manner during their transmissions, such as being transmitted over a same RLC bearer that operates at a particular target PER, then the achieved PSER will not be uniform between the PDU Sets carrying frames that use inter-frame compression and the PDU Sets carrying frames that don't. For example, assuming that a single RLC bearer is configured alone for a DRB supporting the XR video stream and the RLC bearer is configured to operate at a target PER of 10⁻³, and on average, an I frame results in 80 IP packets (i.e., PDUs at the IP layer) and a P frame results in 20 IP packets, and there is one I frame for every 59 P frames (e.g., when the video codec is configured to generate the video frames at 60 FPS with one I frame for every second), the probability for a PDU Set carrying an I frame to be lost during the transmission is equal to (1−(1-10⁻³)⁸⁰)˜=7.7%, and the probability for a PDU Set carrying a P frame to be lost during the transmission is equal to (1−(1-10⁻³)²⁰)˜=2.0%, while the overall probability for losing a PDU Set during the transmission is equal to (7.7%+2%*59)/60˜=2.09%. From the overall probability, which does not consider the implication of a lost PDU Set to other PDU Sets at the application layer, the error performance in the above example may seem OK, e.g., if the target PSER for the entire QoS flow is 3%. However, the achievable PSER among the PDU Sets carrying the I frame has well exceeded that target (i.e., 7.7%>>3%). Although, the target PSER (3%) has been met overall, it has not been met uniformly. More specifically, it has not been met for a category of PDU Sets, which tend to be more critical (than the other PDU Sets) at the application layer.

For example, if the impact of the lost PDU Sets at the application layer is further examined, when an I frame in the above example is lost in the transmission, the subsequent 59 P frames, even if delivered successfully to the recipient, may be unusable by the recipient at the application layer due to the lost I frame, which is needed as a reference for reconstructing the full picture for each of the 59 P frames. In this situation, the user perceived probability of seeing a video frame being in error is equal to (7.7%*60+2%*59)/60˜=9.7%, which is much higher than the overall probability of 2.09%, as computed earlier, and the example target PSER of 3% (according to which metrics, the overall error performance would be considered as satisfactory). In this situation, the PSER may become a performance metrics that is less correlated with the user perceived quality of the communication link and hence less useful. Here, it is assumed that all P frames use the preceding I frame as the reference frame for the inter-frame compression (and the reconstruction). If all P frames use its immediately preceding frame instead, whether that frame being an I frame or a P frame, as the reference frame for the inter-frame compression, losing a P frame earlier in the sequence of consecutive P frames will also affect its following P frames until the next I frame comes up. In this situation, the user perceived probability of seeing a video frame being in error will be even higher than 9.7%.

It may be suggested that the conventional PDCP duplication be deployed on such DRB. For example, two underlying RLC bearers, both being associated with the DRB and each targeting at a PER of 10⁻³, when used alone, can together deliver a combined PER of 10⁻⁶, assuming the transmission errors occur over the two RLC bearers independently (e.g., not due to a severe shadow fading or a coverage hole, which may have simultaneously affected both RLC bearers). However, in the conventional PDCP duplication, every PDU (after being encoded as a PDCP PDU) is duplicated and transmitted over the multiple RLC bearers. On the other hand, to reduce the bandwidth required for delivering the video stream, a video codec typically produces frames using the inter-frame compression (such as P frames or temporal enhancement layer MDUs) far more (e.g., one to two orders of magnitude more) frequently than frames not using the inter-frame compression (such as I frames or base layer MDUs). But as shown in the example above, the user perceived frame errors are predominately due to the loss of frames that do not use the inter-frame compression, such as I frames. Meanwhile, most of the extra bandwidth required for the PDCP duplication are spent on PDUs carrying frames that use the inter-frame compression. However, the gains by spending the extra bandwidth on these PDUs are quite marginal, for two reasons. First, a PDU Set carrying a frame using the inter-frame compression tend to have a small number of PDUs and therefore the probability of the PDU Set being lost in the transmission is already low enough (such as 2.0% among the P frames as computed in the above example). Secondly, the frame carried by such PDU Set may not be used as a reference frame for inter-frame compression (and reconstruction) by any other frames, e.g., when all P frames use only the preceding I frame as the reference, and therefore losing such frame in the transmission does not lead to the user perceived errors in the subsequent frames. Hence, it can be concluded that although the conventional PDCP duplication can be used for delivering an XR video stream to meet a stringent PSER requirement, the radio efficiency in this approach is not optimal, and in fact, may be quite low, because the user perceived reliability issues and impacts on QoE are predominately due to the loss of critical frames that are being dependent upon by other frames, while the extra bandwidth used in boosting the transmission reliability by the conventional PDCP duplication technique are spent mostly on frames other than the critical ones. And as a result, the network capacity, in terms of the number of XR users that can be simultaneously supported, will be reduced. Thus, to better support XR services in a wireless network, new technical solutions are desired for achieving a target PSER in the transmission, and more importantly, a QoE perceived by the end user, while utilizing the radio resources used in the transmission efficiently.

Embodiments of this disclosure provide means for a transmitting entity to classify PDUs of a same video stream received from upper layer for transmission. Further, embodiments of this disclosure provide means for the transmitting entity to handle the PDUs differently during the transmissions in accordance with the classification of the PDUs to meet the target PSER and/or QoE requirements while utilizing the radio resources efficiently for the transmissions. In addition, embodiments of this disclosure minimize the impacts to the design and operations of certain lower protocol layers, such as the physical (PHY) layer, the media access control (MAC) layer, and the RLC layer.

A DRB is configured for delivering PDUs of a video stream, which has a high resolution and a stringent latency requirement, where the PDUs belong to PDU Sets associated with different types of MDUs, different sizes, different importance, and/or with different other characteristics, e.g., regarding whether being dependent upon by another PDU Set or whether being discardable. In the gNB (for a DL video stream) or the UE (for an UL video stream), a transmitting PDCP entity is configured for the DRB to classify the PDUs into at least a first type and a second type, based on the PDU Set that each of the PDUs belongs to. The type of a PDU may be determined based on one or more of the following information: the QFI value associated with the PDU, size of a PDU Set (e.g., in the number of PDUs constituting the PDU Set) that the PDU belongs to, a type of MDU being carried by the PDU Set (e.g., I frame vs. P frame), a PDU Set Importance indication associated with the PDU Set, an inter-PDU-Set dependency information associated with the PDU Set (e.g., the information or a Dependable indication indicating whether the PDU Set being dependent upon by another PDU Set or not), and an Discardable indication associated with the PDU Set (e.g., the indication indicating whether the PDU Set being discardable or not).

The transmitting PDCP entity is associated with multiple underlying RLC bearers. The transmitting PDCP entity is further configured to handle the PDUs for transmission in different manners of utilizing the underlying RLC bearer(s) in accordance with the classification of the PDUs to meet target PSER and/or QoE requirements while utilizing the radio resources efficiently in transmitting the PDUs. In some example embodiments, PDUs classified as of the first type are transmitted over a first RLC bearer that is associated with a lower PER, while PDUs classified as of the second type are transmitted over a second RLC bearer that is associated with a higher PER. In some other example embodiments, the PDUs classified as of the first type are duplicated and transmitted over more than one RLC bearers by using PDCP duplication, while the PDUs classified as of the second type are transmitted over one RLC bearer without using PDCP duplication, where the one RLC bearer used for transmitting the PDUs classified as of the second type may or may not be one of the more than one RLC bearers used for transmitting the PDUs classified as of the first type. In yet some other example embodiments, the PDUs classified as of the first type are duplicated and transmitted over a first number of RLC bearers by using PDCP duplication, while the PDUs classified as of the second type are transmitted over a second number of RLC bearers by using PDCP duplication, the first number being greater than the second number, where some or all of the second number of RLC bearers may or may not be a subset of the first number of RLC bearers.

Information about the PDU types, of which the PDUs are respectively classified as, stays within the transmitting PDCP entity and does not need to be provided to any lower layer protocol entities, such as the PHY entity, the MAC entity, and the RLC entities. Although these lower layer protocol entities may have been configured with some specific operational settings that are suitable for certain type(s) of PDUs as a whole, they operate merely based on their respective configuration and settings, without a need of knowing the dynamic classification of the individual PDUs to be transmitted. For example, in various example embodiments described subsequently, a first RLC entity configured for a first RLC bearer may be configured to operate differently than a second RLC entity configured for a second RLC bearer. However, the first RLC entity or the second RLC entity does not need to know the PDU type associated with an RLC SDU that is submitted to it for a transmission, nor whether the PDU type associated with that RLC SDU is suitable for its specific operational settings or not. Neither of these two RLC entities needs to further differentiate the treatment among the RLC SDUs submitted to it in the way that it handles the transmissions, except that segmentation of an RLC SDU is performed dynamically based on whether the RLC SDU can fit in an available radio resource in its entirety. Therefore, the embodiment techniques described herein have minimal impact on the design and operations of these lower layer protocols and the associated protocol entities.

One purpose for classifying the PDUs is to identify at least a first type of PDUs and a second type of PDUs among the PDUs, where extra bandwidth can be best spent to boost the reliability in transmitting an individual PDU among the first type of PDUs so that the target PSER and/or QoE requirements can be met, while individual PDUs of the second type are transmitted without the extra bandwidth (or at least with less extra bandwidth) being spent to boost the reliability in transmitting them, because it would have less impact on meeting the target PSER and/or QoE requirements. In various example embodiments described herein, the first type of PDUs is classified based on some specific criteria. The second type of PDUs may be classified as any PDUs among the PDUs that cannot be classified as the first type of PDUs. Alternatively, the second type of PDUs may be classified based on some other specific criteria. There may be more types (i.e., other than the first and the second types used in the various examples) of PDUs that the PDUs can be classified as of, e.g., based on yet some other specific criteria, to provide more granularities for differentiating the PDUs and thereby providing differentiated treatment in transmitting them, e.g., by applying different manners in utilizing the underlying RLC bearers when transmitting the PDUs, respectively.

In one example embodiment, the first type of PDUs is identified as having greater importance while the second type of PDUs is identified as having less importance (or, any PDUs other than the first type, as previously described). One type of PDU Set information referred as the PDU Set Importance has been introduced for DL XR traffic by 3GPP SA2, where the UPF is configured by the SMF to determine a PDU Set Importance value associated with a PDU by performing deep packet inspection on certain upper layer protocol header(s) such as an RTP header (or extension header) associated with the PDU at the RTP layer and/or a network adaptation layer (NAL) header (or extension header) associated with the PDU at the NAL layer. The PDU Set Importance may be directly indicated in those headers. Alternatively, the PDU Set Importance may be determined from information carried in those headers in accordance with specific rules for mapping. For example, after performing the deep packet inspection, if the UPF determines that the PDU belongs to a PDU Set that carries an I frame, the UPF associates the PDU with a first value of PDU Set Importance, the first value indicating that the PDU has greater importance. On the other hand, if the UPF determines that the PDU belongs to a PDU Set that carries a P frame, the UPF associates the PDU with a second value of PDU Set Importance, the second value indicating that the PDU has less importance. Then, the UPF provides the determined PDU Set Importance value to the gNB, along with each of the PDUs belonging to the same PDU Set, e.g., by including the PDU Set Importance value in a PDU Set Importance Indication field in a GTP-U extension header of a GTP-U packet sent from the UPF to the gNB, the GTP-U packet encapsulating an associated PDU. Alternatively, the gNB may perform deep packet inspection on a PDU received from upper layers for transmission and determine the importance of the PDU based on similar criteria as described for the UPF.

For a video stream transmitted on the UL, the UE may be configured to determine the PDU Set Importance value associated with each PDU of the video stream. For example, an upper layer protocol entity of the UE, such as an RTP entity or an NAL entity of the UE, while generating a packet (PDU) at the respective protocol layer, may determine the PDU Set Importance value based on similar criteria, e.g., whether an MDU being encapsulated into the RTP packet or the NAL packet is an I frame or a P frame, etc. Then, the upper layer protocol entity provides the determined PDU Set Importance value to the transmitting PDCP entity of the UE through internal cross-layer signaling within the UE. The rules for mapping values of specific information field(s) carried in specific upper layer protocol headers (or extension headers) to PDU Set Importance values may be determined by local configuration of the UE or may be determined by the SMF and provided to the UE by the SMF via an access and mobility management function (AMF) serving the UE (i.e., via non-access-stratum (NAS) signaling).

Then, when the transmitting PDCP entity of the gNB (for the DL video stream) or that of the UE (for the UL video stream) receives a PDU with the first value of PDU Set Importance, the transmitting PDCP entity classifies the PDU as the first type of PDU. When the transmitting PDCP entity receives a PDU with the second value of PDU Set Importance, the transmitting PDCP entity classifies the PDU as the second type of PDU. Or in an alternative example, when the transmitting PDCP entity receives a PDU that cannot be classified as the first type of PDU, the transmitting PDCP entity classifies the PDU as the second type of PDU.

In another example embodiment, the UPF (for DL) or a packet filtering entity of the UE (for UL) may have already mapped the PDUs onto different QoS flows based on the PDU Set Importance value of each PDU, the PDU Set Importance value being determined as described in the previous example embodiment, each QoS flow being identified by a unique QFI. For the DL, the QFI value is provided to the transmitting PDCP entity at the gNB by the UPF, along with a PDU, via the GTP-U extension header of a GTP-U packet carrying the PDU. For the UL, the QFI value is provided to the transmitting PDCP entity of the UE by the packet filtering entity of UE via internal signaling of the UE. In this situation, the transmitting PDCP entity may use the QFI associated with a PDU to infer the PDU Set Importance value associated with the PDU and thereby classify the PDU accordingly, as described before.

In yet another example embodiment, the transmitting PDCP entity may classify a PDU as being the first type or the second type based on what type of MDU (e.g., I frame or P frame, base layer MDU or enhancement layer MDU, etc.) is carried by the PDU. For example, for the DL video stream, the UPF, after performing the deep packet inspection on a PDU and determining the MDU type information from information retrieved from certain upper layer protocol (such as RTP or NAL) header or extension header, may provide the gNB with information about the type of MDU that the PDU carries, e.g., by including the information about the MDU type in the GTP-U extension header of the GTP-U packet that carries the PDU. Alternatively, the gNB may perform deep packet inspection on a PDU received from upper layers for transmission and determine the type of MDU being carried by the PDU, in a similar manner as described for the UPF. For the UL video stream, the upper layer protocol (such as RTP or NAL) entity of the UE, while generating a PDU of the video stream at the respective protocol layer, may provide the information about the type of MDU being encapsulated into the PDU to the PDCP layer of the UE via internal cross-layer signaling within the UE.

Then, when the transmitting PDCP entity of the gNB (for the DL video stream) or that of the UE (for the UL video stream) receives a PDU associated with an MDU type of I frame or base layer MDU, the transmitting PDCP entity classifies the PDU as the first type of PDU. When the transmitting PDCP entity receives a PDU associated with an MDU type of P frame or enhancement layer MDU (or receives a PDU that cannot be classified as the first type of PDU), the transmitting PDCP entity classifies the PDU as the second type of PDU.

In yet another example embodiment, the transmitting PDCP entity may classify a PDU as being the first type or the second type based on whether a PDU Set, which the PDU belongs to, carries an MDU that is being dependent upon by another MDU. An MDU is being dependent upon by another MDU if the MDU is used as a reference frame for the inter-frame compression when generating (or on the recipient side, when reconstructing) the another MDU; otherwise, the MDU is not being dependent upon by any other PDUs. Discarding an MDU that is being dependent upon by other MDU(s) or losing it in the transmission may render the other MDUs unusable by the application layer of the recipient, even if they are successfully delivered to the recipient, therefore resulting in more severe impact to the user perceived reliability of the communication link or QoE. On the other hand, discarding or losing an MDU that is not being dependent upon by any other MDUs may have limited impact to the user perceived reliability of the communication link or QoE. Such inter-dependency information may also be referred to and/or encoded as a Dependable indication or a Discardable indication. In some example embodiments, the inter-dependency information may provide a simple indication of Yes or No as to whether the MDU being dependent upon or not, or for the Dependable indication, whether the MDU being dependable or not, or for the Discardable indication, whether the MDU being discardable or not. In some other example embodiments, a hierarchical prediction may be used among a sequence of consecutive frames of a video stream, where the relationship of inter-frame dependency may be depicted by a string of letters made of letters “I,” “P,” and “p,” where “I” refers to the I frames or IDR frames, “P” refers to a type of P frame that is also used as a reference frame for inter-frame compression by a subsequent “P” frame or “p” frame, and “p” refers to a type of P frame that is not used as a reference frame for the inter-frame compression by any other frames. For example, a string of “IpPpPpPp” describes a pattern where there is one “p” frame for every other frame (of any type), there is one I frame or one “P” frame between two adjacent “p” frames, and there is one I frame for every three “P” frames, and the pattern repeats for every 8 consecutive frames. In this situation, all I frames may be assigned with a first value of the Dependable indication corresponding to “the most dependable,” and/or assigned with a first value of the Discardable indication corresponding to “the least discardable.” All “P” frames may be assigned with a second value of the Dependable indication corresponding to “more dependable,” and/or assigned with a second value of the Discardable indication corresponding to “less discardable.” And all “p” frames may be assigned with a third value of the Dependable indication corresponding to “not dependable” or “the least dependable,” and/or assigned with a third value of the Discardable indication corresponding to “the most discardable.” If there are more than three distinct levels of hierarchies used in the hierarchical prediction, then more than three values may be defined to represent more granularities in indicating the inter-dependency information.

The inter-dependency information may have been generated by the source video codec for each MDU and included in an upper layer protocol (such as RTP or NAL) header or extension header associated with each PDU. For the DL video stream, the UPF, after performing the deep packet inspection on a PDU, may retrieve the inter-dependency information and provide it to the gNB, e.g., by including the information in the GTP-U extension header of the GTP-U packet that carries the PDU. Alternatively, the gNB may perform deep packet inspection on a PDU received from upper layers for transmission and retrieve the inter-dependency information on its own. For the UL video stream, the upper layer protocol (such as RTP or NAL) entity of the UE, while generating a PDU of the video stream at the respective protocol layer, may provide the inter-dependency information, which is provided to them by the source video codec on the UE, to the PDCP layer of the UE via internal cross-layer signaling within the UE.

Then, when the transmitting PDCP entity of the gNB (for the DL video stream) or that of the UE (for the UL video stream) receives a PDU associated with an inter-dependency information indicating that the PDU carries an MDU that is being dependent upon by other MDU(s), or associated with a value of the Dependable indication indicating that the PDU carries an MDU that is dependable (or more dependable or the most dependable), or associated with a value of the Discardable indication indicating that the PDU carries an MDU that is not (or less or the least) discardable, the transmitting PDCP entity classifies the PDU as the first type of PDU. On the other hand, when the transmitting PDCP entity receives a PDU associated with an inter-dependency information indicating that the PDU carries an MDU that is not being dependent upon by any other MDUs, or associated with another value of the Dependable indication indicating that the PDU carries an MDU that is not (or the least) dependable, or associated with another value of the Discardable indication indicating that the PDU carries an MDU that is discardable (or the most discardable), or receives a PDU that cannot be classified as the first type of PDU, the transmitting PDCP entity classifies the PDU as the second type of PDU. When there are more granularities in the inter-dependency information, e.g., when values of the Dependable indication can indicate the least, less, more, and the most dependable (or when values of the Discardable indication can indicate the least, less, more, and the most discardable), respectively, the PDUs can be classified among more than two types to provide differentiated treatment in the transmission with more granularities, as stated before.

In yet another example embodiment, the transmitting PDCP entity may classify a PDU as being the first type or the second type based on a size of a PDU Set that the PDU belongs to. The size of the PDU Set may be measured as a total number of PDUs that constitute the PDU Set. As previously described, the motivation is that a PDU Set with a larger number of PDUs needs a lower target PER in transmitting the individual PDUs to achieve a target PSER, while the same target PSER can be achieved for another PDU Set with a smaller number of PDUs by targeting the transmission of those individual PDUs at a higher PER. The size of the PDU Set may be determined by the source video codec and provided as a part of the metadata of the MDU. For the DL video stream, the UPF, after performing the deep packet inspection on the PDU or receiving the metadata of the MDU over the N6 interface, may determine the total number of PDUs of the PDU Set that the PDU belongs to and then provide the size information to the gNB, e.g., by including the PDU Set size information in the GTP-U extension header of a GTP-U packet sent from the UPF to the gNB, the GTP-U packet encapsulating the PDU. For the UL video stream, the PDU Set size information, once determined by the source video codec on the UE, may be conveyed to the transmitting PDCP entity of the UE through internal cross-layer signaling within the UE.

Then, when the transmitting PDCP entity of the gNB (for the DL video stream) or that of the UE (for the UL video stream) receives a PDU associated with a PDU Set of a size (in a total number of PDUs) that is greater than a pre-specified threshold, the transmitting PDCP entity classifies the PDU as the first type of PDU; otherwise, transmitting PDCP entity classifies the PDU as the second type of PDU. Alternatively, more than one thresholds for the PDU Set size may be pre-specified and used in the classification so that the PDUs may be classified among more than two types, based on the PDU Set size of the PDU Set that a PDU belongs to, in order to provide differentiated treatment in the transmission with more granularities, as stated before.

In yet another example embodiment, the transmitting PDCP entity may classify a PDU as being the first type or the second type based on a remaining time (e.g., duration) until a delivery deadline associated with the PDU, e.g., based on whether the remaining time being greater than or less than a pre-specified threshold. For example, ideally speaking, PDUs belonging to a same PDU Set should normally arrive at the transmitting PDCP entity roughly at the same time. However, sometimes, a PDU of a PDU Set may arrive at the transmitting PDCP entity much later than the other PDUs belonging to the same PDU Set, because, for example, this PDU may be delivered by a retransmission over a transport network after the initial transmission of it over the transport network has failed. In this situation, this PDU has a much shorter remaining time, when it finally arrives at the transmitting PDCP entity, for a successful transmission over the RAN before a deadline is reached for decoding and displaying the video picture carried by the whole PDU Set. The shorter remaining time could mean fewer number of automatic repeat request (ARQ) retransmissions and/or fewer number of hybrid ARQ (HARQ) retransmissions that can be carried out, if needed, at the lower layers (such as the RLC layer for ARQ retransmissions and the MAC layer for HARQ retransmission) to ensure the successful transmission over the RAN. Therefore, in this example embodiment, the transmitting PDCP entity may classify this belated PDU as being the first type due to its remaining time being shorter than the pre-specified threshold, even if the transmitting PDCP entity may have previously classified the other PDUs of the same PDU Set as being the second type. For another example, currently with the conventional solution, it is typically assumed that delay budget requirements for PDUs within a same QoS flow are relatively uniform. However, as upper layer protocols (such as quick UDP Internet connection (QUIC)) are evolving to better support multimedia services, it is possible that different PDUs or different PDU Sets within a same QoS flow may have different delay budget requirements, and hence when these PDUs arrive at the transmitting PDCP entity, they may have different remaining time durations until their respective delay budgets are ran out. Hence, similarly, the transmitting PDCP entity may classify PDUs associated with a remaining time shorter than the pre-specified threshold as being the first type while classifying PDUs associated with a remaining time longer than the pre-specified threshold as being the second type, and based thereon, transmit these PDUs differently in accordance with the classification. Classifying PDUs with a shorter remaining time as the first type and hence transmitting them using the extra bandwidth (e.g., via a more reliable bearer and/or via more bearers) to boost the transmission reliability will help to mitigate the impact on the final error performance due to their lack of time for adequate number of ARQ retransmissions and/or HARQ retransmissions at the lower layers.

In yet some other example embodiments, the classification of the PDUs may be done based on a combination of two or more of the above example methods and criteria. Rules for mapping the PDU type values with information associated with the combined criteria may be determined by the SMF and provided to the gNB (for the DL video stream) and to the UE (for the UL video stream). Alternatively, the rules for the mapping may be generated by the gNB or the UE, based on its local configuration.

In various example embodiments described herein, the transmitting PDCP entity may be associated with multiple underlying RLC bearers, and each RLC bearer is served by an RLC entity on the sender side and another RLC entity on the recipient side. One embodiment technique for utilizing these multiple RLC bearers to provide differentiated treatment in transmitting the PDUs based on their classifications is referred to as the enhanced split bearers or as the dynamic bearer switching. Another embodiment technique for utilizing these multiple RLC bearers to provide differentiated treatment in transmitting the PDUs based on their classifications is referred to as the selective PDCP duplication. One benefit for transmitting individual PDUs of different classes differently is to support more superior error performance in transmitting the individual PDUs of at least one class than the error performance in transmitting the individual PDUs of at least another class. In various embodiments, boosting the reliability in transmitting the PDUs of the at least one class helps to ensure that the PSER, which is another error performance measured at the PDU Set (or application) level, can be more uniformly met among all classes, or a lower PSER can be met for the at least one class than for the at least another class, or the belated PDUs can be successfully transmitted more quickly to make up for the extra delay already incurred on them. In the following sections, these two techniques are described individually in detail. However, a combination of these two techniques is also possible.

In the conventional split bearers, a transmitting PDCP entity may be associated with multiple RLC bearers, and packets (i.e., PDCP data PDUs) generated by the transmitting PDCP entity are split among the multiple RLC bearers based on whether a total volume of data pending for transmission has exceeded a specific threshold or not. In any case, a packet is transmitted using only one of the multiple RLC bearers. Each of the multiple RLC bearers is configured to operate at roughly a same target PER (as measured at the RLC layer), which is also same as the final target PER measured at the PDCP layer, so that no matter how the packets are split among the multiple RLC bearers for transmission, the final target PER measured at the PDCP layer can be met. Such mechanism for using split bearers for transmission would be inadequate for an XR video stream, as the data splitter (which is inside the transmitting PDCP entity) is unaware of a type and/or a characteristic of the data that is being transmitted.

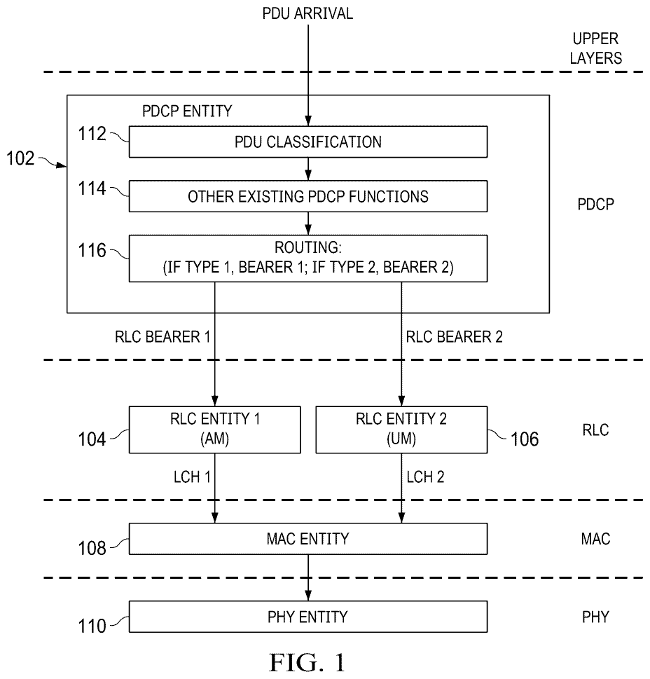

In some example embodiments of the enhanced split bearers, as illustrated in FIG. 1, the transmitting PDCP entity 102 is associated with at least a first RLC bearer and a second RLC bearer, the first RLC bearer being served by a first RLC entity 104 of the sender and being associated with a lower PER performance or being configured to operate at a lower target PER (as measured at the RLC layer), and the second RLC bearer being served by a second RLC entity 106 of the sender and being associated with a higher PER performance or being configured to operate at a higher target PER. One way for configuring these two RLC bearers to operate at different target PERs is to configure the first RLC entity 104 and the second RLC entity 106 to operate at different RLC modes. For example, the first RLC entity 104 may be configured to operate at the RLC acknowledged mode (AM) mode and the second RLC entity 106 is configured to operate at the RLC unacknowledged mode (UM) mode, wherein the ARQ retransmission mechanism, which is supported in the RLC AM but not in RLC UM, helps to make the first RLC bearer more reliable than the second RLC bearer.

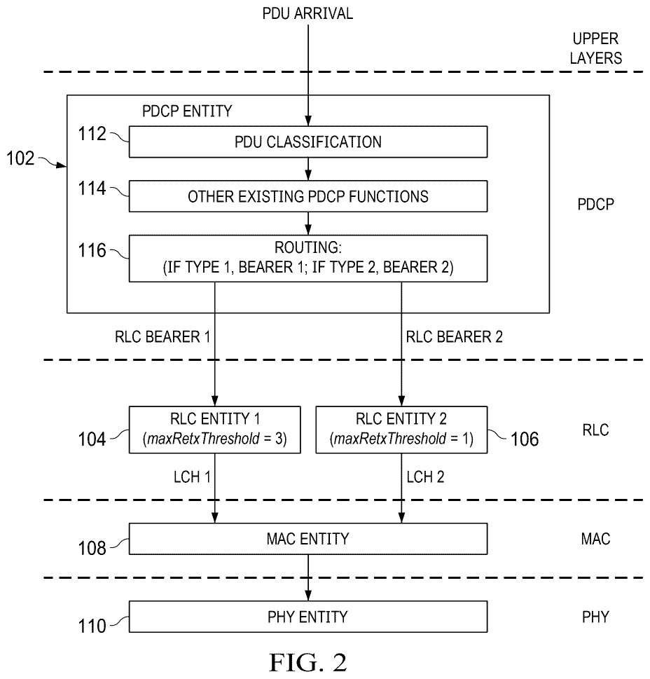

As illustrated in FIG. 2, another way for configuring the first RLC bearer 104 and the second RLC bearer 106 to operate at different target PERs is to configure both the first RLC entity 104 and the second RLC entity 106 to operate at the RLC AM mode, but with different values for a parameter referred to as the maxRetxThreshold, which specifies the maximal numbers of ARQ retransmissions allowed for any RLC PDU served by that RLC entity. For example, the first RLC entity 104 is configured with a larger value (such as 3 as illustrated in FIG. 2) of maxRetxThreshold, which can result in a lower residual error rate after the maximal number of, e.g., three, ARQ retransmissions are exhausted, while the second RLC entity 106 is configured with a smaller value (such as 1 as illustrated in FIG. 2) of maxRetxThreshold, which can result in a residual error rate that is higher than that of the first RLC bearer, after the maximal number of, e.g., one, ARQ retransmission is exhausted.

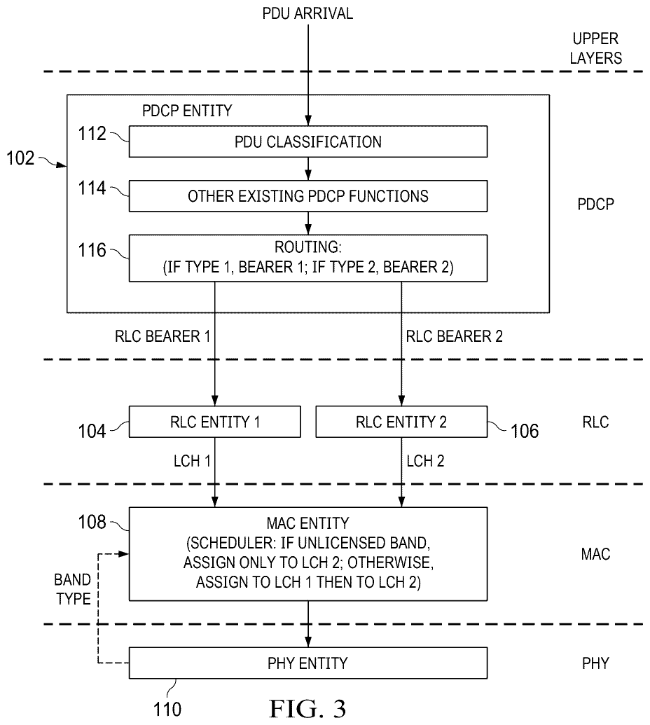

The first RLC entity 104 and the second RLC entity 106 further interacts with an underlying MAC entity 108 via a unique logical channel (LCH), respectively. For example, the first RLC entity 104 interacts with the MAC entity 108 via a first LCH and the second RLC entity 106 interacts with the MAC entity 108 via a second LCH. The MAC entity 108 is responsible for scheduling PHY layer radio sources for transmission of data that are available at the transmission buffers of the respective LCHs. Hence, yet another way for configuring the first RLC bearer and the second RLC bearer to operate at different target PERs is, in a configuration referred to as the mac-LogicalChannelConfig, to configure certain restriction of what type of PHY radio resources can be used for which LCH (and hence for which associated RLC bearer). For example, a restriction, referred to as the band-restriction, can be that the MAC entity 108 can assign a transmission opportunity to the first LCH if the radio resources used is on a licensed band; otherwise, not to the first LCH, if the radio resources used is on an unlicensed band (as transmissions over the unlicensed band may be less reliable). Meanwhile, the second LCH is not configured with such restriction. Transmissions over an unlicensed band tend to be less reliable than transmissions over a licensed band due to that interference over the unlicensed band tends to be less predictable and less manageable than that over the licensed band. As illustrated in FIG. 3, the PHY entity 110 provides a Band type indication to the MAC entity 108 indicating whether a radio resource available for scheduling a transmission opportunity is on an unlicensed band or not. Then, the MAC scheduler at the MAC entity 10, when scheduling the transmission opportunity using the available radio resource, assigns the transmission opportunity to only the second LCH (denoted as LCH 2 in FIG. 3) if the radio resource used is on the unlicensed band; otherwise, assigns to transmission opportunity first to the first LCH (denoted as LCH 1 in FIG. 3) if there is data available on the first LCH for transmission. If there is no data available on the first LCH for transmission, or after packing all available data on the first LCH into the available radio resource, if there is still room left for packing more data, the MAC scheduler further assigns any remaining radio resource to the second LCH if there is data available on the second LCH for transmission. For another example, a restriction, herein referred to as the modulation and coding scheme (MCS)-restriction, can be that the MAC entity 108 can assign a transmission opportunity to the first LCH only if the MCS level to be used for the transmission opportunity is below a specific MCS level; otherwise, not assign the transmission opportunity to the first LCH. Meanwhile, the second LCH is not configured with such restriction. As a rule of thumb, given a same channel condition and same data, the lower the MCS level used in transmitting the data, the higher probability that the data will be transmitted successfully. The band-restriction and/or the MCS-restriction can be configured for the first RLC entity (and not for the second RLC entity) together with the different RLC modes of operation (i.e., AM vs. UM) or different maxRetxThreshold values being configured for the first and second RLC entities, respectively.

After receiving a PDU, which is considered as a PDCP SDU, from upper layer for transmission and classifying the PDU, as previously described and as illustrated in FIGS. 1-3 (denoted as the PDU classification functional block 112 in FIGS. 1-3), the transmitting PDCP entity further processes the PDCP SDU to generate a PDCP PDU (denoted as the functional block of other existing PDCP functions block 114 in FIGS. 1-3). Then, the transmitting PDCP entity 102 submits the PDU to the first RLC entity 104 for transmission if the PDU has been classified as of the first type, otherwise the transmitting PDCP entity 102 submits the PDU to the second RLC entity 106 for transmission if the PDU has been classified as of the second type. This operation is illustrated as the functional block of Routing 116 in FIGS. 1-3, which is enhanced with the novel criteria for splitting data (PDUs) among the multiple underlying RLC bearers.

If the PDUs can be classified with more granularities (i.e., more than the first type and the second type in the examples illustrated in FIGS. 1-3), as previously described, then more than two underlying RLC bearers (and the associated RLC entities and LCHs) can be configured to operate at different target PERs, so that more granularities in providing differentiated treatment in transmission among the PDUs can be supported based on their respective classifications.

In the conventional PDCP duplication, the transmitting PDCP entity is associated with more than one underlying RLC bearers that are activated in order for the transmitting PDCP entity to perform PDCP duplication. And while performing PDCP duplication, all PDCP PDUs produced by the transmitting PDCP entity are duplicated and transmitted over all activated RLC bearers, without considering a type or a characteristic of the packets being transmitted. Such PDCP duplication would be inefficient in utilizing the radio resources because the extra bandwidths are blindly applied to all the packets, without considering how a transmission error occurred on different types of packets would impact the user perceived reliability of the communication link or the QoE.

In some example embodiments, the transmitting PDCP entity 102 is associated with multiple underlying RLC bearers, which are activated. Each of the multiple RLC bearers may or may not be associated with a same or similar PER performance (or be configured to operate at a same or similar target PER), as measured at the RLC layer. And, at least for the first type of PDUs classified by the transmitting PDCP entity 102, as previously described, none of the multiple RLC bearers needs to be configured to (operate at a target PER that is adequate to) meet the target PSER and/or QoE requirements, as measured among the first type of PDUs, if that RLC bearer is used alone for delivering the first type of PDUs. If a PDU has been previously identified as of the first type, instead of using a single RLC bearer, the transmitting PDCP entity 102 duplicates the PDU (after processing it into a PDCP PDU) and transmits a copy over each of a first number of RLC bearers among the multiple RLC bearers, by submitting the copy of the PDCP PDU to the underlying RLC entities that are configured for the first number of RLC bearers, respectively.

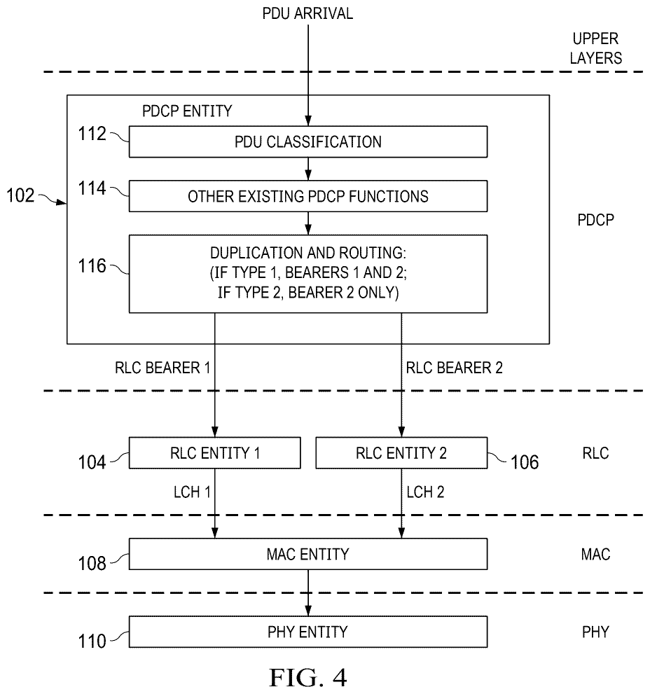

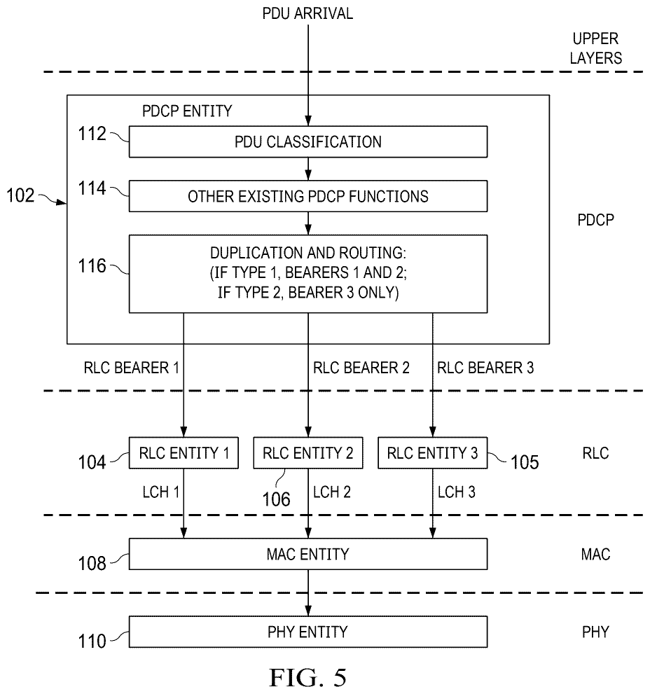

In a first example embodiment, for the second type of PDUs, one of the multiple RLC bearers is associated with a PER performance (or is configured to operate at a target PER) that is adequate to meet the target PSER and/or QoE requirements, as measured among the second types of PDUs, if the one of the multiple bearers is used alone for delivering the second type of PDUs. In this situation, if a PDU has been previously identified as of the second type, the transmitting PDCP entity 102 transmits the PDU (after processing it into a PDCP PDU) over the one of the multiple RLC bearers, by submitted the PDCP PDU to an underlying RLC entity that is configured for the one of the multiple RLC entities. In one example, the one of the multiple RLC bearers is one of the first number of RLC bearers, as illustrated in FIG. 4. In an alternative example, the one of the multiple RLC bearers is not any of the first number of RLC bearers, as illustrated in FIG. 5. As shown in FIG. 4, the transmitting PDCP entity 102 is associated with two RLC bearers (denoted as RLC bearer 1 and RLC bearer 2, respectively) and two underlying RLC entities (denoted as RLC Entity 104 and RLC Entity 106, respectively). RLC entity 104 and RLC entity 106 may be configured to operate in the same RLC mode, e.g., both in the RLC AM mode or both in the RLC UM mode. Alternatively, RLC entity 104 and RLC Entity 106 may be configured to operate in different RLC modes, e.g., one being in the RLC AM mode and the other being in the RLC UM mode. When both RLC entity 104 and RLC entity 106 are configured to operate in the RLC AM mode, they may be further configured with the same maxRetxThreshold value or different maxRetxThreshold values.

As shown in FIG. 5, the transmitting PDCP entity 102 is associated with three RLC bearers (denoted as RLC bearer 1, RLC bearer 2, and RLC bearer 3, respectively) and three underlying RLC entities (denoted as RLC entity 104, RLC entity 106, and RLC entity 105, respectively). These three RLC entities may be configured to operate in the same RLC mode or in different RLC modes. When they are configured to operate in the RLC AM mode, they may be further configured with the same maxRetxThreshold value or different maxRetxThreshold values.

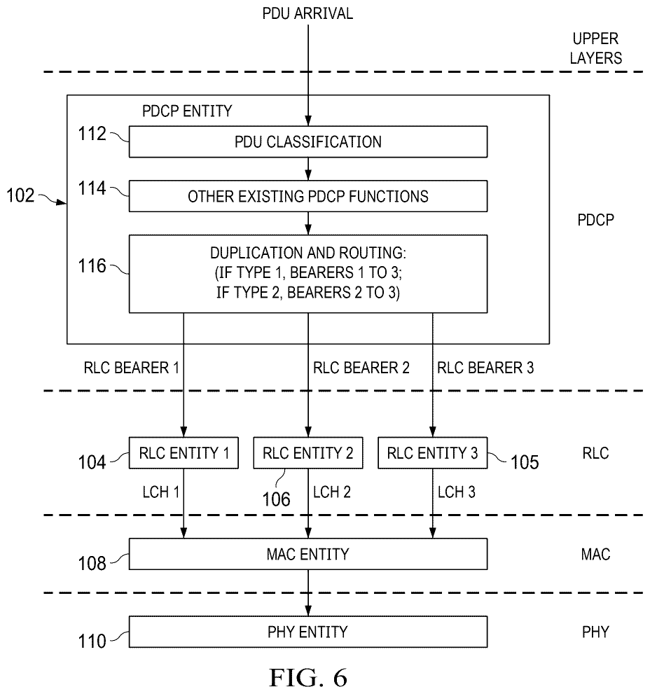

In a second example embodiment, for the second type of PDUs classified by the transmitting PDCP entity 102, as previously described, none of the multiple RLC bearers is associated with a PER performance (or is configured to operate at a target PER) that is adequate to meet the target PSER and/or QoE requirements, as measured among the second type of PDUs, if that RLC bearer is used alone for delivering the second type of PDUs. If a PDU has been previously identified as of the second type, instead of using a single RLC bearer (as illustrated in FIGS. 4 and 5), the transmitting PDCP entity 102 also duplicates the PDU (after processing it into a PDCP PDU) and transmits a copy over each of a second number of RLC bearers among the multiple RLC bearers, by submitting the copy of the PDCP PDU to the underlying RLC entities that are configured for the second number of RLC bearers, respectively, the second number being smaller than the first number. The second number of RLC bearers may be a subset of the first number of bearers used for transmitting the first type of PDUs. Alternatively, the second number of RLC bearers may partially overlap with the first number of bearers. Yet alternatively, the second number of RLC bearers and the first number of bearers may be mutually exclusive. FIG. 6 illustrates the case where the second number of RLC bearers used for transmitting the second type of PDUs are a subset of the first number of bearers that are used for transmitting the first type of PDUs.

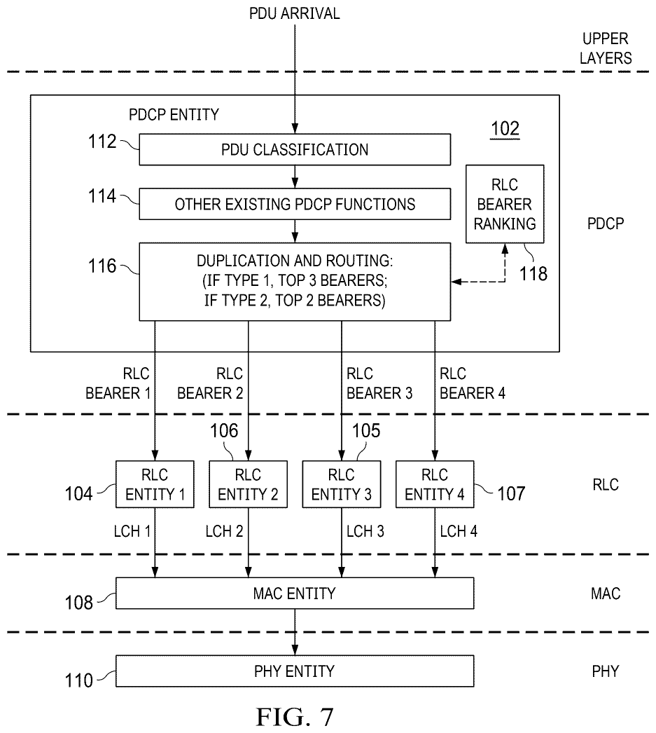

In some example embodiments, the identities of the first number of RLC bearers used for transmitting the first type of PDUs may be pre-configured and therefore be fixed until the configuration is changed, as illustrated in FIGS. 4-6, and so is the case for the second number of RLC bearers used for transmitting the second type of PDUs, as illustrated in FIG. 6. In some other example embodiments, although value of the first number (and value of the second number) is pre-configured and fixed, the exact RLC bearers that make up the first number (or the second number) of RLC bearers may be determined dynamically based on a latest performance of each of the multiple RLC bearers and a ranking among them in accordance with the respective performance, at a time when the PDCP duplication is to be made. For example, as shown in FIG. 7, the transmitting PDCP entity 102 is associated with four RLC bearers (denoted as RLC bearer 1, RLC bearer 2, RLC bearer 3, and RLC bearer 4, respectively) and four underlying RLC entities (denoted as RLC entity 104, RLC entity 106, RLC entity 105, and RLC entity 107, respectively). As illustrated in FIG. 7, an RLC bearer ranking functional block in the transmitting PDCP entity 102 constantly monitors the performance (such as an error performance or a throughput performance) of each of the multiple RLC bearers and ranks the multiple RLC bearers according to their performance. When a PDU of the first type is to be duplicated and transmitted, the top 3 RLC bearers (as the first number being 3 in the example illustrated in FIG. 7), as currently ranked by the RLC bearer ranking function, are selected for transmitting the duplicated copy of the PDU of the first type. When a PDU of the second type is to be duplicated and transmitted, the top 2 RLC bearers (as the second number being 2 in the example illustrated in FIG. 7), as currently ranked by the RLC bearer ranking function, are selected for transmitting the duplicated copy of the PDU of the second type. In addition to the RLC bearer performance, when ranking the multiple RLC bearers, the RLC bearer ranking functional block may further consider a cell-load condition of a cell that the each of the multiple RLC bearers is established over.

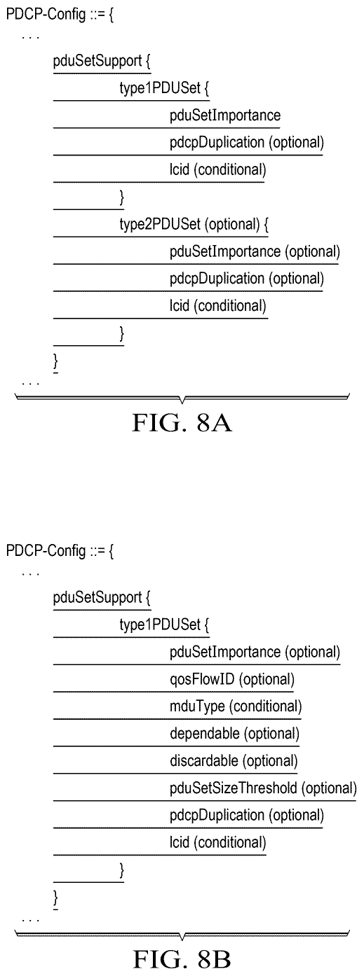

In the above example embodiments, the transmitting PDCP entity, if being on the UE side, is configured by the gNB serving the UE to perform the PDU classification in the accordance with the specific information and criteria associated with the various methods as described above. The gNB sends an RRC signaling message to configure the transmitting PDCP entity of the UE, the message includes an information field referred to as the PDCP-Conf. In the PDCP-Conf, a new field referred to as the pduSetSupport field may be inserted within the PDCP-Conf field to indicate the configuration for PDU type classification and type-specific handling (for the transmission). Its presence in the PDCP-Conf field also indicates that the associated DRB supports the transport of PDU Set. If this field is present in the PDCP-Conf field, it includes at least a field referred to as the type1PDUSet field. FIG. 8A illustrates the signaling of a configuration with this pduSetSupport field, by using one of the previously described example embodiments, where the PDU Type is classified based on an importance of the PDU Set that the PDU belongs to. Text being underscored in FIG. 8A represents new information fields.

As shown in FIG. 8A, the type1PDUSet field indicates the configuration for identifying Type 1 PDUs and handling Type 1 PDUs in transmission (regarding which underlying RLC bearers and associated logical channels (LCHs) are to be used in transmitting the PDU). The type1PDUSet field is present in the pduSetSupport field. The type2PDUSet field is optionally present. The type2PDUSet field is absent when Type 2 PDUs are classified as any non-Type-1 PDUs and PDCP duplication isn't used for Type 2 PDUs; otherwise, the type2PDUSet field is present to indicate specific configuration for identifying and/or handling Type 2 PDUs. The pduSetImportance field within the type1PDUSet field indicates the PDU Set Importance values that correspond to Type 1 PDUs. The PDU Set Importance values corresponding to Type 1 PDUs may be individually indicated in the pduSetImportance field within the type1PDUSet field. Alternatively, the pduSetImportance field within the type1PDUSet field may indicate a threshold value of the PDU Set Importance, any PDU Set Importance values less than the threshold value corresponding to Type 1 PDUs and any PDU Set Importance values greater than the threshold value corresponding to Type 2 PDUs. The pduSetImportance field is optionally present in the type2PDUSet field. It may be absence in the type2PDUSet field when Type 2 PDUs are classified as any non-Type-1 PDUs (i.e., any PDUs that cannot be classified as Type 1). If present in the type2PDUSet field, the pduSetImportance field indicates the PDU Set Importance values that correspond to Type 2 PDUs. For illustration purpose, the pduSetImportance field is shown as being included in the type1PDUSet field. If another previously described classification method is to be configured, the pduSetImportance field may be replaced by another new field. For example, if the classification method based on the QFI is to be configured, a new field referred to as the gosFlowID field may be included in the type1PDUSet field and/or the type2PDUSet field to indicate the QFI values that corresponds to the associated type. For another example, if the classification method based on the MDU type is to be configured, a new field referred to as the mduType field may be included in the type1PDUSet field and/or the type2PDUSet field to indicate the MDU Type values that corresponds to the associated PDU type. For yet another example, if the classification method based on the Dependable indication is to be configured, a new field referred to as the dependable field may be included in the type1PDUSet field and/or the type2PDUSet field to indicate the values of the Dependable indication that corresponds to the associated PDU type. For yet another example, if the classification method based on the Discardable indication is to be configured, a new field referred to as the discardable field may be included in the type1PDUSet field and/or the type2PDUSet field to indicate the values of the Discardable indication that corresponds to the associated PDU type. Similarly, the MDU Type values (or the Dependable indication values or the Discardable indication values) corresponding to Type 1 PDUs may be individually indicated in the mduType field (or the dependable field or the discardable field) within the type1PDUSet field. Alternatively, the mduType field (or the dependable field or the discardable field) within the type1PDUSet field may indicate a threshold value of the MDU Type (or of the Dependable indication or of the Discardable indication), any MDU Type values (or any Dependable indication values or any Discardable indication values) less than the threshold value corresponding to Type 1 PDUs and any MDU Type values (or any Dependable indication values or any Discardable indication values) greater than the threshold value corresponding to Type 2 PDUs. For yet another example, if the classification method based on the PDU Set Size (e.g., in number of PDUs) is to be configured, a new field referred to as the pduSetSizeThreshold field may be included in the type1PDUSet field to indicate a PDU Set size threshold, where a PDU is classified as of the first type (Type 1) if being associated with a PDU Set size above the threshold, or otherwise, be classified as of the second type (Type 2), etc. For yet another example, if the classification method based on the remaining time is to be configured, a new field that may be referred to as the remainingTimeThreshold field may be included in the type1PDUSet field to indicate a remaining time threshold, where a PDU is classified as of the first type (Type 1) if being associated with a remaining time below the threshold, or otherwise, classified as of the second type (Type 2), etc.

The pdcpDuplication field indicates that PDCP duplication is to be used for Type 1 PDUs when the pdcpDuplication field is included in the type1PDUSet field, and is to be used for the Type 2 PDUs when the pdcpDuplication field is included in the type2PDUSet field. If the pdcpDuplication field is absent, PDCP duplication is not used for the associated type of PDUs. The lcid field indicates a list of LCH IDs (LCIDs) associated with the RLC entities, to which the PDU is to be submitted for transmission. The presence of this field may be conditioned on that the associated pdcpDuplication field is present and indicating “True” for using PDCP duplication. When PDCP duplication is not enabled, this field may be absent. In this situation (i.e., when duplication not enabled), Type 1 PDUs are submitted to the primary RLC entity associated with the transmitting PDCP entity and Type 2 PDUs are submitted to the secondary RLC entity associated with the transmitting PDCP entity.

FIG. 8B illustrates the signaling of an alternative configuration where the first type of (Type 1) PDUs may be identified using multiple classification methods, as previously described. In fact, all the classification methods previously described may be included in FIG. 8B. However, it should be understood that any combinations of a subset of them are also possible. The meanings of the various fields have been previously described, except that final classification of a PDU as the Type 1 PDU may be a result of logic “AND” (or alternatively, logic “OR”) of the respective classification results from the multiple classification methods. For example, a PDU is classified as the Type 1 PDU if all of the multiple methods can otherwise individually classify the PDU as the Type 1 PDU. For another example, a PDU is classified as the Type 1 PDU if at least one of the multiple methods can otherwise individually classify the PDU as the Type 1 PDU. To simplify the illustration, there is no type2PDUSet field in FIG. 8B, because it may be assumed in this case that the second type of (Type 2) PDUs are classified as any PDUs that cannot be classified as the Type 1 PDUs and PDCP duplication is not to be used on Type 2 PDUs. Alternatively, it is also possible to include a type2PDUSet field to explicitly indicate the classification criteria for classifying a PDU as the Type 2 PDU and/or to explicitly indicate how Type 2 PDUs should be transmitted, e.g., by including another pdcpDuplication field and another lcid field within the type2PDUSet field to indicate whether and/or how PDCP duplication should be applied on the Type 2 PDUs.

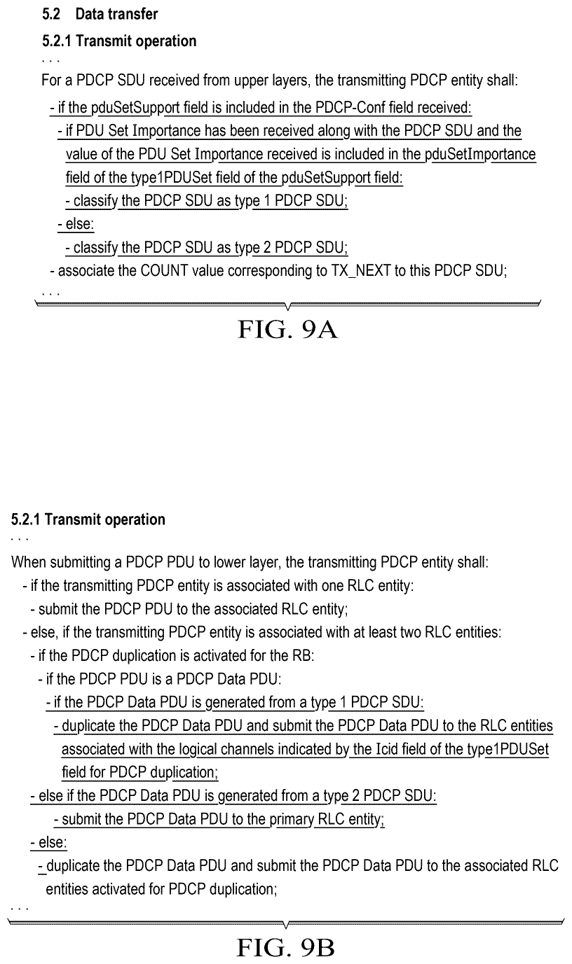

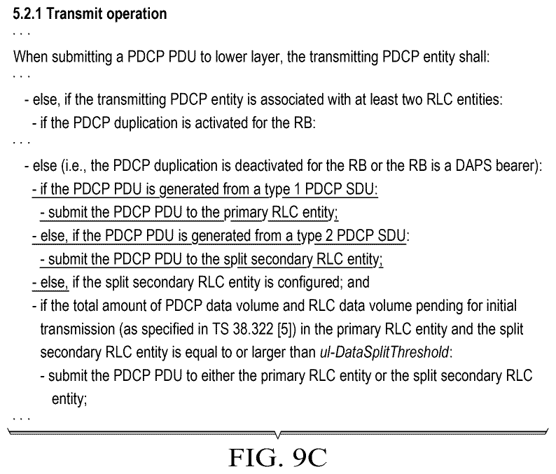

As the transmitting PDCP entity being configured by the above example configuration signaling, the transmitting PDCP entity may follow the procedure described in FIG. 9A to perform the PDU classification by using the information fields being provided with. Again, for illustration purpose, FIG. 9A uses the method of using the PDU Set Importance to classify PDUs as an example. Using other previously described classification methods is also possible. Text being underscored in FIG. 9A describes new behaviors of the transmitting PDCP entity.

As the transmitting PDCP entity having classified a PDU, the transmitting PDCP entity may follow the procedure described in FIG. 9B to perform the transmission of the PDU by using the configuration being provided with, in accordance with the technique referred to as the selective PDCP duplication, as previously described. Text being underscored in FIG. 9B describes new behaviors of the transmitting PDCP entity, which are different than those in the conventional PDCP duplication. In this example, the second type of (Type 2) PDUs are transmitted without using PDCP duplication, like the example illustrated in FIG. 4. Hence, the Typ2 PDUs are transmitted by using only one underlying RLC bearer, e.g., the primary one as illustrated in FIG. 9B (however, using the secondary RLC bearer is also possible).

Alternatively, the transmitting PDCP entity may follow the procedure described in FIG. 9C to perform the transmission of the PDU by using the configuration being provided with, in accordance with the technique referred to as the enhanced split bearers or dynamic bearer switching, as previously described. Text being underscored in FIG. 9C describes new behaviors of the transmitting PDCP entity, which are different than those in the conventional split bearers.

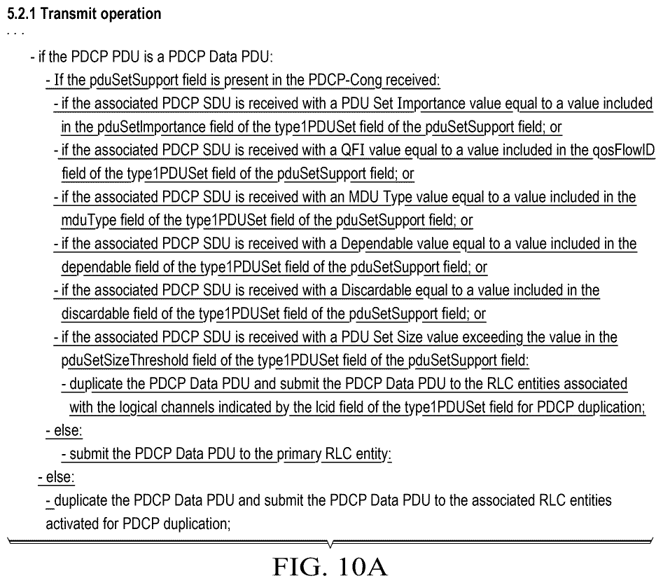

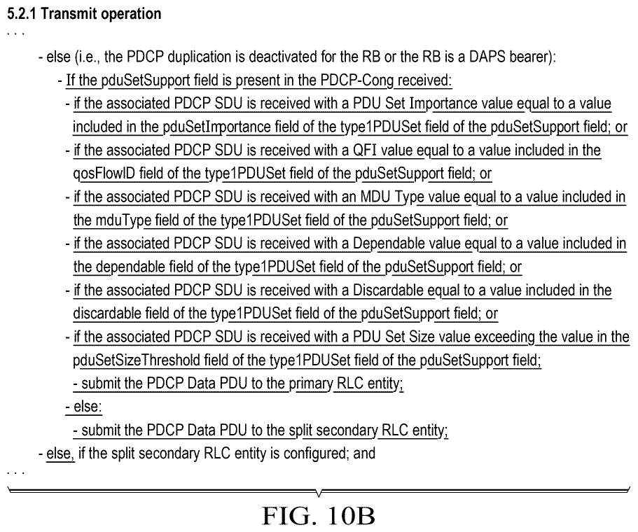

Classifying PDUs by types and then transmitting the PDUs based on the types have been described in the various example embodiments as two separate logical steps. In alternative embodiments, these two steps can be executed as one, or considering the step of PDU classification being skipped. Take the example illustrated in FIG. 8B for example, the configuration signaling in FIG. 8B has provided all the valid values of respective parameters that correspond to Type 1 PDU. And the actions to be taken for Type 1 PDU have also been provided in the pdcpDuplication field and the lcid field, with regard to whether to transmit Type 1 PDU with PDCP duplication, and if yes, using which underlying RLC bearers and associated LCHs. Therefore, it is conceivable that the transmitting PDCP entity can directly use a value of a classification parameter being provided by upper layer, e.g., by the UPF to the gNB (for DL), or by the upper layer of the UE to the PDCP layer of the UE, to determine whether that value is a valid value (i.e., being among the valid values) being configured with (e.g., in the type1PDUSet field as illustrated in FIG. 8B), if yes, then take the actions being configured with in association with those valid values, e.g., transmit the PDU with PDCP duplication using the RLC bearers configured in the configuration signaling; if not, then take a default action, e.g., transmit the PDU using a single and pre-specified RLC bearer, such as the primary RLC bearer or the secondary RLC bearer. FIG. 10A illustrates an example of such two-step-in-one procedure to perform the transmission of the PDU with the selective (i.e., type-dependent) PDCP duplication without going through a middle step of literally determining the PDU type. FIG. 10B illustrates another example of such two-step-in-one procedure to perform the transmission of the PDU with the enhanced (i.e., type-dependent) split bearers without going through a middle step of literally determining the PDU type. Again, classification parameters related to all the previously described classification methods may be included in FIGS. 10A and 10B, as an example. It should be understood that using any single one or any subset of these parameters is also possible.

In the above examples, as illustrated in FIGS. 8A-10B, the type1PDUSet field may be referred to by another name, e.g., as the priorityPDUSet field, or when only one specific classification method is used, as the largePDUSet field, the importantPDUSet field, the urgentPDUSet field, etc., depending on the method being used. Type 1 PDUs may also be referred to as, e.g., PDUs of priority PDU Set, PDUs of large PDU Set, PDUs of important PDU Set, PDUs of urgent PDU Set, etc. The type2PDUSet field may also be referred to as, e.g., the non-priorityPDUSet field, the smallPDUSet field, the unimportantPDUSet field, the non-urgentPDUSet field, etc. And similarly, Type 2 PDUs may also be referred to as, e.g., PDUs of non-priority PDU Set, PDUs of small PDU Set, PDUs of unimportant PDU Set, PDUs of non-urgent PDU Set, etc.

Other wireless communication systems may also be used in delivering XR video traffic. Therefore, in the general, the embodiment techniques disclosed herein may also be used in some other wireless communication systems with the similar benefits. For example, IEEE 802.11 is currently developing a new amendment referred to as 802.11be, which is also known as Wi-Fi 7, where multiple 802.11 links may be established between a station (STA) and one or more access points (APs). If data packets are simply split among the multiple links without considering a type or a characteristic associated with the packets, then a target QoS (such as PSER) or QoE requirement may not be met uniformly among the data. On the other hand, if all the packets are duplicated and transmitting over all of the multiple links without considering the type or the characteristic associated with the packets, the radio efficiency will be suboptimal or even very low, and meanwhile, interference may be aggravated due to a large number of unnecessarily duplicated transmissions. Therefore, the embodiment techniques for classifying packets by the sender and methods for differentiated treatment in transmitting the packets based on the classification, including the type-specific data splitting and the selective packet duplication, can also be applied to 802.11be or to further enhance 802.11be in a future amendment.

H.264/AVC and SVC video encoding standards and certain specific types of frames or MDUs used in them, such as I frame, P frame, base layer, enhancement layer have been mentioned in the various example embodiments. However, the embodiment techniques described herein should not be construed as being suitable only to those video standards or to those specific types of MDUs. The various techniques described herein can also be used for delivering a video traffic generated by any other existing video standards, such as H.265 (HEVC) and H.266 (VVC), or future video standards, such as those yet to be developed for 3-demensional video, to ensure target performance or QoE can be met uniformly within the video traffic.

In the various example embodiments described above, the classification of the PDUs of the same QoS flow and the transmitting of the PDUs differently (e.g., via different bearers and/or different numbers of bearers) in accordance with the classification are performed by the transmitting PDCP entity, wherein the multiple bearers are RLC bearers, while keeping the underlying RLC entities and MAC entity largely unchanged. Alternatively, it is also possible that the classification of the PDUs and the transmitting of the PDUs differently in accordance with the classification are performed by the SDAP entity above the transmitting PDCP entities, wherein the multiple bearers are DRBs, while keeping the underlying transmitting PDCP entities, RLC entities, and MAC entity largely unchanged. For example, the SDAP entity is associated with multiple transmitting PDCP entities, the multiple transmitting PDCP entities being configured for the multiple DRBs, respectively. The transmitting of the PDUs differently in accordance with the classification may be performed by the SDAP entity by mapping PDUs classified as different types onto different DRBs among the multiple DRBs, where the different DRBs are configured to achieve different error performances (or target PER rates), or by mapping the PDUs classified as the different types onto different numbers of DRBs among the multiple DRBs to achieve different degrees of duplication, which result in different error performances (or target PER rates).

In various example embodiments described above, the classification of PDUs of a same QoS flow and handling transmission of the PDUs differently in accordance with the classification are described as two logical steps. It is also possible to execute the two steps as one, e.g., handling the transmission of the PDUs of the same QoS flow differently based on whether a respective PDU meets one or more specific conditions, where the one or more specific conditions are the same ones that would be used in the classification in the two-step approach.

In the various example embodiments described above, the various embodiment techniques have been illustrated and described by using a video traffic, more specifically an XR video traffic, as the illustrative example traffic that is being delivered by a wireless system, which is enhanced by the various techniques. However, it should not be construed that these embodiment techniques are only suitable for delivering video traffic. The various techniques described herein can also be used for delivering a traffic of any other existing or future media or data services, such as a service of artificial intelligence, machine learning, metaverse, or digital twin, etc., as long as the traffic includes periodic or semi-periodical bursts of high-volume data, where the size of each data burst, the type of each data burst, or characteristic of the data burst (such as an importance, whether being dependent upon by other data bursts, whether being depending on other data bursts, whether being discardable, etc.) may vary from burst to burst, and the traffic has a stringent latency requirement, which cause the conventional transmission techniques to be inadequate or inefficient.

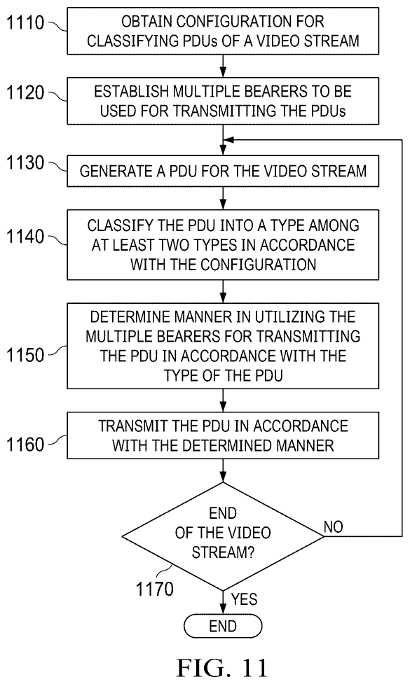

FIG. 11 illustrates a flow diagram of example operations 1100 occurring in a UE. Operations 1100 may be indicative of operations occurring in a UE, as the UE transmits PDUs of a video stream.

Operations 1100 begin with the UE obtaining information used for classifying PDUs of the video stream (operation 1110). The PDUs of the video stream are generated by a video application client on the UE for a video session established on the UE. The information used for the classifying may be obtained from an SMF selected to manage the video session. Alternatively, the information used for the classifying may be obtained in accordance with a local configuration of the UE. Yet alternatively, the information used for the classifying may be obtained partially from the SMF and partially in accordance with the local configuration of the UE. The information used for the classifying may include a specific number of types that the PDUs may be classified as, information about one or more information fields that are used for determining the type of a PDU, and rules for mapping the specific number of types with the associated values of the one or more information fields, where the information about the one or more information fields may include the names of the one or more information fields, the protocol ID(s) of the protocol header(s) where the one or more information fields can be found, and the specific locations of the one or more information fields within the respective protocol headers, etc.

The UE establishes multiple bearers (e.g., multiple RLC bearers) to be used for transmitting the PDUs (operation 1120). For example, the UE establishes the multiple RLC bearers in accordance with a configuration referred to as the RLC-BearerConfig and provided by a gNB serving the UE. The RLC-BearerConfig further includes information (referred to as the DRB-Identity) indicates that the multiple RLC bearers are associated with the DRB that is configured for the video stream. The RLC-BearerConfig further includes information for configuring multiple RLC entities on the UE to serve the multiples RLC bearers from the sender side. Therefore, the UE also establishes the multiple RLC entities accordingly. The UE also receives information for configuring a transmitting PDCP entity associated with the DRB. Therefore, the UE also establishes the transmitting PDCP entity accordingly. The RLC-BearerConfig may further include information about the possible PDU types and respective numbers of top-ranking RLC bearers to be used for transmitting the respective types of PDU, as previously described above. Alternatively, the RLC-BearerConfig may further include information about the possible PDU types and respective sets of RLC bearer IDs of the RLC bearers to be used for transmitting the respective types of PDU. For example, an RLC bearer ID may be expressed as the LCID of an LCH that a uniquely associated with the RLC bearer, as previously described above.

The UE generates a PDU for the video stream (operation 1130). For example, the video application client of the UE may generate a PDU at the application layer. Then, an RTP entity of the UE may generate an RTP packet (i.e., PDU at RTP layer) to encapsulate the PDU at the application layer. Then, the RTP packet is further encapsulated in a user datagram protocol (UDP) packet (i.e., PDU at the UDP layer), which is then further encapsulated in an IP packet (i.e., PDU at the IP layer).

As the PDU (e.g., the IP packet) arrives at the transmitting PDCP entity of the UE, it is also referred to as a PDCP SDU. The UE classifies the PDU into a type among at least two types, as previously described and illustrated, in accordance with the configuration obtained in operation 1110 (operation 1140). For example, the UE uses a PDU classification function within the transmitting PDCP entity of the UE to classify the PDU. For example, the at least two types include the first type and the second type, as previously described. Then, the UE continues the other PDCP processing to convert the PDU (PDCP SDU) into a PDCP PDU.

Then, the UE determines a manner in utilizing the multiple underlying bearers (e.g., multiple RLC bearers) for transmitting the PDU in accordance with the type of the PDU, as classified in operation 1140 (operation 1150). For example, when the type of the PDU is the first type, the UE determines that the manner is to transmit the PDU with PDCP duplication using a first number of RLC bearers among the multiple RLC bearers. When the type of the PDU is the second type, the UE determines that the manner is to transmit the PDU using a second number of RLC bearers among the multiple RLC bearers, the second number being less than the first number. If the second number is more than one, PDCP duplication is also used in transmitting the PDU of the second type. The UE transmits the PDU in accordance with the determined manner (operation 1160). The UE determines whether it is the end of the video stream (operation 1170). If not, the UE goes back to operation 1130. Otherwise, operations 1100 may end.

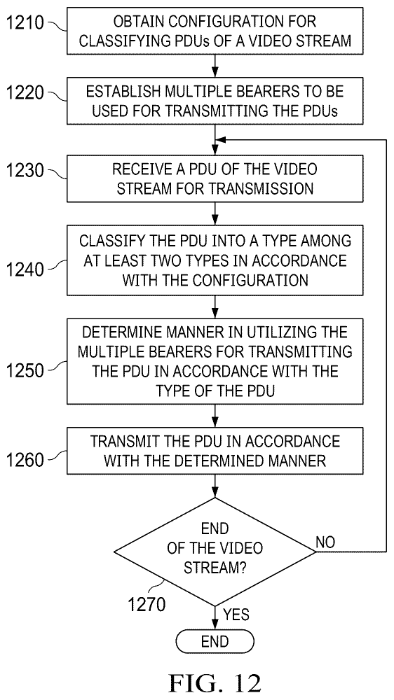

FIG. 12 illustrates a flow diagram of example operations 1200 occurring in a gNB. Operations 1200 may be indicative of operations occurring in a gNB, as the gNB transmits PDUs of a video stream.

Operations 1200 begin with the gNB obtaining information used for classifying PDUs of the video stream (operation 1210). The PDUs of the video stream are generated by a video application server in the network and to be used by a video application client on a UE, the UE being served by the gNB for a video session established on the UE. The information used for the classifying may be obtained from an SMF selected to manage the video session. Alternatively, the information used for the classifying may be obtained in accordance with a local configuration of the gNB. Yet alternatively, the information used for the classifying may be obtained partially from the SMF and partially in accordance with the local configuration of the gNB. The information used for the classifying may include a specific number of types that the PDUs may be classified as, information about one or more information fields that are used for determining the type of a PDU, and rules for mapping the specific number of types with the associated values of the one or more information fields, where the information about the one or more information fields may include the names of the one or more information fields, the protocol ID(s) of the protocol header(s) where the one or more information fields can be found, and the specific locations of the one or more information fields within the respective protocol headers, etc.

The gNB establishes multiple bearers (e.g., multiple RLC bearers) to be used for transmitting the PDUs (operation 1220). For example, the gNB may determine a total number of the multiple RLC bearers to be established in accordance with the specific number of types that the PDUs may be classified as, a target PSER, a QoE requirement, target PERs that each of the multiple RLC bearers may be respectively met, an estimated average PDU Set size (in a total number of PDUs constituting the PDU Set) associated with the respective types, etc. The gNB also establishes multiple RLC entities in the gNB to serve the multiples RLC bearers from the sender side. the gNB also establishes a transmitting PDCP entity in the gNB for a DRB that is established for the video stream. The gNB further sends an RRC signaling message to the UE, the RRC signaling message includes configuration information about the DRB and the multiple RLC bearers established for the video stream, configuration information for the UE to establish multiple RLC entities in the UE to serve the multiples RLC bearers from the recipient side, configuration information for the UE to establish a receiving PDCP entity associated with the DRB and the multiple RLC entities.

The gNB receives a PDU for the video stream from its upper layers (operation 1230). For example, the video application server in the network may have generated the PDU of the application layer, then, an RTP entity associated with the server may generate an RTP packet (i.e., PDU at RTP layer) to encapsulate the PDU of the application layer, and then, the RTP packet is further encapsulated in a UDP packet (i.e., PDU at the UDP layer), which is then further encapsulated in an IP packet (i.e., PDU at the IP layer).

As the PDU (e.g., the IP packet) arrives at the transmitting PDCP entity of the gNB, it is also referred to as a PDCP SDU. The gNB classifies the PDU into a type among at least two types, as previously described and illustrated, in accordance with the configuration obtained in operation 1210 (operation 1240). For example, the gNB uses a PDU classification function within the transmitting PDCP entity of the gNB to classify the PDU. For example, the at least two types include the first type and the second type, as previously described. Then, the gNB continues the other PDCP processing to convert the PDU (PDCP SDU) into a PDCP PDU.

Then, the gNB determines a manner in utilizing the multiple underlying bearers (e.g., multiple RLC bearers) for transmitting the PDU in accordance with the type of the PDU, as classified in operation 1240 (operation 1250). For example, when the type of the PDU is the first type, the gNB determines that the manner is to transmit the PDU with PDCP duplication using a first number of RLC bearers among the multiple RLC bearers. When the type of the PDU is the second type, the gNB determines that the manner is to transmit the PDU using a second number of RLC bearers among the multiple RLC bearers, the second number being less than the first number. If the second number is more than one, PDCP duplication is also used in transmitting the PDU of the second type. The gNB transmits the PDU to the UE in accordance with the determined manner (operation 1260). The gNB determines whether it is the end of the video stream (operation 1270). If not, the gNB goes back to operation 1230. Otherwise, operations 1200 may end.

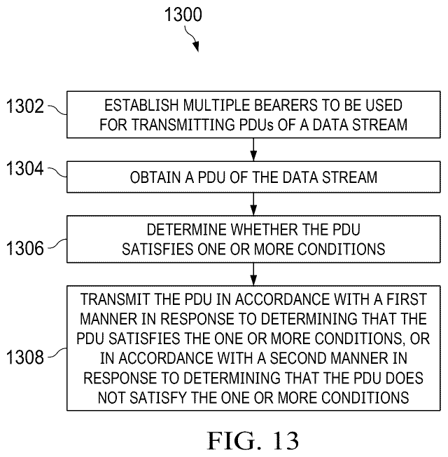

FIG. 13 shows a flow chart of a method 1300 performed by an apparatus, according to some embodiments. The apparatus may include computer-readable code or instructions executing on one or more processors of the apparatus. Coding of the software for carrying out or performing the method 1300 is well within the scope of a person of ordinary skill in the art having regard to the present disclosure. The method 1300 may include additional or fewer operations than those shown and described and may be carried out or performed in a different order. Computer-readable code or instructions of the software executable by the one or more processors may be stored on a non-transitory computer-readable medium, such as for example, the memory of the apparatus. In some embodiments, the method 1300 may be performed by one or more of units or modules (e.g., an integrated circuit) of the apparatus, such as field programmable gate arrays (FPGAs) or application-specific integrated circuits (ASICs).

The method 1300 starts at the operation 1302, where the apparatus establishes multiple bearers to be used for transmitting protocol data units (PDUs) of a data stream. In some alternative embodiments, the multiple bearers may optionally be already established. For example, the multiple bearers may have already been established by another entity, such as a receiving device that receives the PDUs of the data stream transmitted by the apparatus. At the operation 1304, the apparatus obtains a PDU of the data stream. At the operation 1306, the apparatus determines whether the PDU satisfies one or more conditions. At the operation 1308, the apparatus transmits the PDU in accordance with a first manner in response to determining that the PDU satisfies the one or more conditions, or in accordance with a second manner in response to determining that the PDU does not satisfy the one or more conditions. The second manner is different from the first manner in which one or more bearers among the multiple bearers are utilized in transmitting the PDU.

In some embodiments, the apparatus may classify the PDU as a first type or a second type based on a result of the determining whether the PDU satisfies the one or more conditions, the first type corresponding to satisfying the one or more conditions, and the second type corresponding to not satisfying the one or more conditions. Transmitting the PDU in accordance with the first manner may be in response to classifying the PDU as the first type. Transmitting the PDU in accordance with the second manner may be in response to classifying the PDU as the second type.

In some embodiments, the apparatus may be or may be part of a user equipment (UE). The UE may obtain the PDU from an upper layer of the UE. The UE may transmit the PDU to a base station serving the UE.

In some embodiments, the apparatus may be or may be part of a base station. The base station may receive the PDU from a core network node. The base station may transmit the PDU to a UE served by the base station.

In some embodiments, the apparatus may obtain configuration about the one or more conditions associated with the PDUs of the data stream. The apparatus may determine whether the PDU satisfies the one or more conditions in accordance with the configuration.

In some embodiments, the configuration may indicate a PDU Set size threshold. The apparatus may obtain a total number of all PDUs in a PDU Set that the PDU belongs to. The apparatus may determine that the PDU satisfies the one or more conditions in response to the total number being greater than the PDU Set size threshold or determine that the PDU does not satisfy the one or more conditions in response to the total number being less than the PDU Set size threshold.

In some embodiments, the configuration may indicate at least a first set of PDU Set importance values and a second set of PDU Set importance values. The first set of PDU Set importance values may correspond to satisfying the one or more conditions. The second set of PDU Set importance values may correspond to not satisfying the one or more conditions. The apparatus may obtain a PDU Set importance value of the PDU Set that the PDU belongs to. The apparatus may determine that the PDU satisfies the one or more conditions in response to the PDU Set importance value being among the first set of PDU Set importance values or determine that the PDU does not satisfy the one or more conditions in response to the PDU Set importance value being among the second set of PDU Set importance values.

In some embodiments, the configuration may indicate a time threshold. The apparatus may obtain a remaining time until a delivery deadline associated with the PDU. The apparatus may determine that the PDU satisfies the one or more conditions in response to the remaining time being less than the time threshold or determine that the PDU does not satisfy the one or more conditions in response to the remaining time being greater than the time threshold.

In some embodiments, the configuration may indicate at least a first set of media data unit (MDU) type values and a second set of MDU type values. The first set of MDU type values may correspond to satisfying the one or more conditions. The second set of MDU type values may correspond to not satisfying the one or more conditions. The apparatus may obtain an MDU type value of an MDU carried by the PDU Set that the PDU belongs to. The apparatus may determine that the PDU satisfies the one or more conditions in response to the MDU type value being among the first set of MDU type values or determine that the PDU does not satisfy the one or more conditions in response to the MDU type value being among the second set of MDU type values.

In some embodiments, the configuration may indicate at least a first set of inter-dependency indication values and a second set of inter-dependency indication values. The first set of inter-dependency indication values may correspond to satisfying the one or more conditions. The second set of inter-dependency indication values may correspond to not satisfying the one or more conditions. The apparatus may obtain an inter-dependency indication value of the PDU Set that the PDU belongs to. The apparatus may determine that the PDU satisfies the one or more conditions in response to the inter-dependency indication value being among the first set of inter-dependency indication values or determine that the PDU does not satisfy the one or more conditions in response to the inter-dependency indication value being among the second set of inter-dependency indication values.

In some embodiments, the configuration may indicate at least a first set of discardable indication values and a second set of discardable indication values. The first set of discardable indication values may correspond to satisfying the one or more conditions. The second set of discardable indication values may correspond to not satisfying the one or more conditions. The apparatus may obtain a discardable indication value of the PDU Set that the PDU belongs to. The apparatus may determine that the PDU satisfies the one or more conditions in response to the discardable indication value among the first set of discardable indication values or determine that the PDU does not satisfy the one or more conditions in response to the discardable indication value being among the second set of discardable indication values.

In some embodiments, the multiple bearers may be multiple radio link control (RLC) bearers. Determining whether the PDU satisfies the one or more conditions may be performed by a packet data convergence protocol (PDCP) entity of the apparatus.

In some embodiments, the apparatus may transmit in the first manner by submitting the PDU to a first RLC entity configured for a first RLC bearer among the multiple RLC bearers. The apparatus may transmit in the second manner by submitting the PDU to a second RLC entity configured for a second RLC bearer among the multiple RLC bearers. The first RLC bearer may be configured to be more reliable than the second RLC bearer.

In some embodiments, the first RLC entity may be configured to operate in an RLC acknowledged mode (AM). The second RLC entity is configured to operate in an RLC unacknowledged mode (UM).

In some embodiments, the first RLC entity may be configured to operate in an RLC AM with a third number of RLC retransmissions maximally allowed. The second RLC entity may be configured to operate in the RLC AM with a fourth number of RLC retransmissions maximally allowed. The third number may be greater than the fourth number.

In some embodiments, the apparatus may configure a media access control (MAC) entity of the apparatus with a restriction. The MAC entity may be associated with the first RLC bearer. The restriction may prohibit the MAC entity from assigning a transmission opportunity to a logical channel associated with the first RLC bearer. The transmission opportunity may utilize an unlicensed band.

In some embodiments, the apparatus may transmit in the first manner by submitting the PDU to a first number of RLC entities respectively configured for a first number of RLC bearers among the multiple RLC bearers. The apparatus may transmit in the second manner by submitting the PDU to a second number of RLC entities respectively configured for a second number of RLC bearers among the multiple RLC bearers. The first number may be greater than the second number.

In some embodiments, the apparatus may transmit in the first manner by using PDCP duplication to duplicate the PDU for the submitting to the first number of RLC bearers. The apparatus may transmit in the second manner by using PDCP duplication to duplicate the PDU for the submitting to the second number of RLC bearers. The second number may be greater than one.

In some embodiments, the multiple bearers may be multiple data radio bearers (DRBs). Determining whether the PDU satisfies the one or more conditions may be performed by a service data adaptation protocol (SDAP) entity of the apparatus.

In some embodiments, the apparatus may transmit in the first manner by submitting the PDU to a first PDCP entity of the apparatus. The first PDCP entity may be configured for a first DRB among the multiple DRBs. The apparatus may transmit in the second manner by submitting the PDU to a second PDCP entity of the apparatus. The second PDCP entity may be configured for a second DRB among the multiple DRBs. The first DRB may be configured to be more reliable than the second DRB.

In some embodiments, the apparatus may transmit in the first manner by submitting the PDU to a fifth number of PDCP entities of the apparatus. The fifth number of PDCP entities may be respectively configured for a fifth number of DRBs among the multiple DRBs. The apparatus may transmit in the second manner by submitting the PDU to a sixth number of PDCP entities of the apparatus. The sixth number of PDCP entities may be respectively configured for a sixth number of DRBs among the multiple DRBs. The fifth number may be greater than the sixth number.

In some embodiments, the data stream may be a video stream of a same quality of service (QoS) flow.

Various embodiment methods are provided for a sender of an XR video stream to classify PDUs received from upper layers for transmission. The classification helps to identify PDUs, among the PDUs, where extra bandwidth can be best utilized in boosting the reliability in transmitting them to meet the target PSER and/or QoE requirements, while maintaining the radio efficiency optimal by not spending the extra bandwidth to boost the reliability in transmitting the other PDUs where it would have less impact on meeting the target PSER and/or QoE requirements.

Various embodiment methods are provided for the sender of the XR video stream to handle the PDUs differently during the transmissions in accordance with the classification of the PDUs to meet the target PSER and/or QoE requirements while utilizing the radio resources efficiently for the transmissions. One of the methods is referred to as the enhanced split bearers or as the dynamic bearer switching. Another of the methods is referred to as the selective PDCP duplication. Combination of these two methods is also possible.

Embodiment techniques in this disclosure support better quality of experience for XR services by minimizing the number of video frames perceived as in error by the end user. Embodiment techniques in this disclosure allow the gNB and the UE to utilize the radio resources efficiently when transmitting an XR video stream. Embodiment techniques in this disclosure minimize the impact on the design and operations of lower layers such as PHY, MAC, and RLC layers. These lower layers are not only unaware of the PDU types but also unaware of the notion of PDU Set in the first place. These lower layers continue to handle the PDU at PDU level, mostly in a streamline manner based on the existing static or semi-static configurations so that these lower layers' state machines can be kept relatively simple. If that these lower layers were to operate with the awareness of the types, which are dynamic, then their state machines can become very complex.

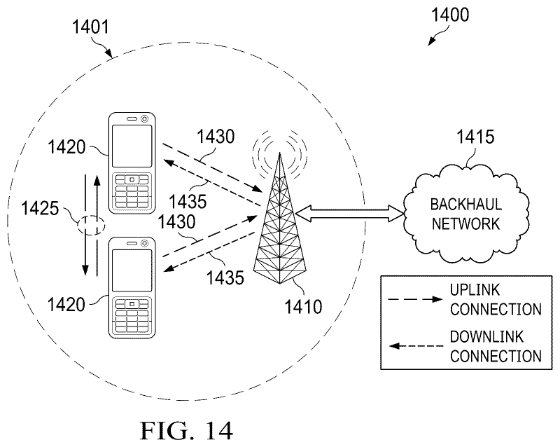

FIG. 14 illustrates an example communications system 1400. Communications system 1400 includes an access node 1410 serving user equipments (UEs) with coverage 1401, such as UEs 1420. In a first operating mode, communications to and from a UE passes through access node 1410 with a coverage area 1401. The access node 1410 is connected to a backhaul network 1415 for connecting to the internet, operations and management, and so forth. In a second operating mode, communications to and from a UE do not pass through access node 1410, however, access node 1410 typically allocates resources used by the UE to communicate when specific conditions are met. Communications between a pair of UEs 1420 can use a sidelink connection (shown as two separate one-way connections 1425). In FIG. 14, the sideline communication is occurring between two UEs operating inside of coverage area 1401. However, sidelink communications, in general, can occur when UEs 1420 are both outside coverage area 1401, both inside coverage area 1401, or one inside and the other outside coverage area 1401. Communication between a UE and access node pair occur over uni-directional communication links, where the communication links between the UE and the access node are referred to as uplinks 1430, and the communication links between the access node and UE is referred to as downlinks 1435.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

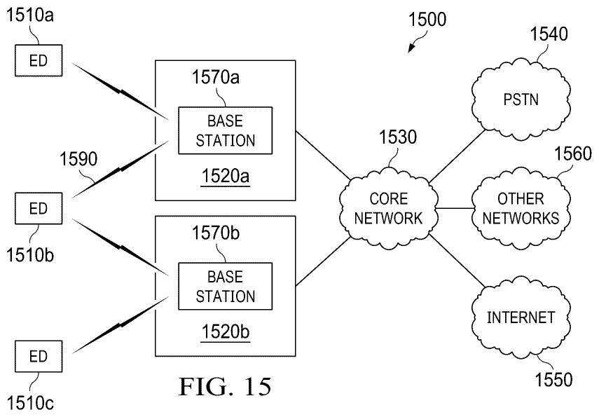

FIG. 15 illustrates an example communication system 1500. In general, the system 1500 enables multiple wireless or wired users to transmit and receive data and other content. The system 1500 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1500 includes electronic devices (ED) 1510a-1510c, radio access networks (RANs) 1520a-1520b, a core network 1530, a public switched telephone network (PSTN) 1540, the Internet 1550, and other networks 1560. While certain numbers of these components or elements are shown in FIG. 15, any number of these components or elements may be included in the system 1500.

The EDs 1510a-1510c are configured to operate or communicate in the system 1500. For example, the EDs 1510a-1510c are configured to transmit or receive via wireless or wired communication channels. Each ED 1510a-1510c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1520a-1520b here include base stations 1570a-1570b, respectively. Each base station 1570a-1570b is configured to wirelessly interface with one or more of the EDs 1510a-1510c to enable access to the core network 1530, the PSTN 1540, the Internet 1550, or the other networks 1560. For example, the base stations 1570a-1570b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1510a-1510c are configured to interface and communicate with the Internet 1550 and may access the core network 1530, the PSTN 1540, or the other networks 1560.

In the embodiment shown in FIG. 15, the base station 1570a forms part of the RAN 1520a, which may include other base stations, elements, or devices. Also, the base station 1570b forms part of the RAN 1520b, which may include other base stations, elements, or devices. Each base station 1570a-1570b operates to transmit or receive wireless signals within a particular geographic region or area, sometimes referred to as a “cell.” In some embodiments, multiple-input multiple-output (MIMO) technology may be employed having multiple transceivers for each cell.

The base stations 1570a-1570b communicate with one or more of the EDs 1510a-1510c over one or more air interfaces 1590 using wireless communication links. The air interfaces 1590 may utilize any suitable radio access technology.

It is contemplated that the system 1500 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1520a-1520b are in communication with the core network 1530 to provide the EDs 1510a-1510c with voice, data, application, Voice over Internet Protocol (VoIP), or other services. Understandably, the RANs 1520a-1520b or the core network 1530 may be in direct or indirect communication with one or more other RANs (not shown). The core network 1530 may also serve as a gateway access for other networks (such as the PSTN 1540, the Internet 1550, and the other networks 1560). In addition, some or all of the EDs 1510a-1510c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1550.

Although FIG. 15 illustrates one example of a communication system, various changes may be made to FIG. 15. For example, the communication system 1500 could include any number of EDs, base stations, networks, or other components in any suitable configuration.

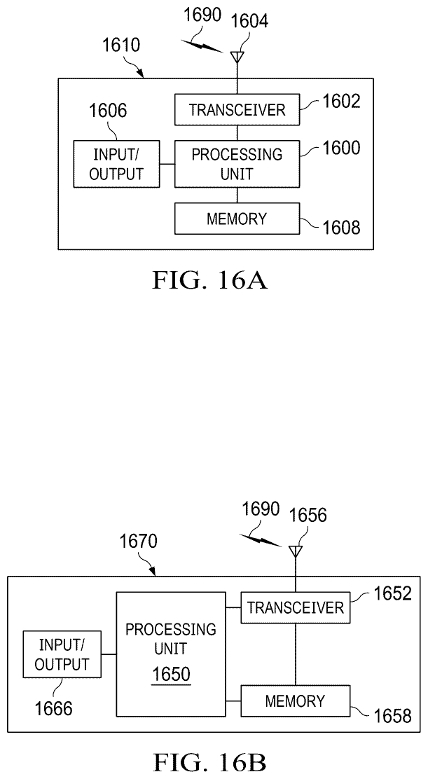

FIGS. 16A and 16B illustrate example devices that may implement the methods and teachings according to this disclosure. In particular, FIG. 16A illustrates an example ED 1610, and FIG. 16B illustrates an example base station 1670. These components could be used in the system 1500 or in any other suitable system.

As shown in FIG. 16A, the ED 1610 includes at least one processing unit 1600. The processing unit 1600 implements various processing operations of the ED 1610. For example, the processing unit 1600 could perform signal coding, data processing, power control, input/output processing, or any other functionality enabling the ED 1610 to operate in the system 1500. The processing unit 1600 also supports the methods and teachings described in more detail above. Each processing unit 1600 includes any suitable processing or computing device configured to perform one or more operations. Each processing unit 1600 could, for example, include a microprocessor, microcontroller, digital signal processor, field programmable gate array, or application specific integrated circuit.

The ED 1610 also includes at least one transceiver 1602. The transceiver 1602 is configured to modulate data or other content for transmission by at least one antenna or NIC (Network Interface Controller) 1604. The transceiver 1602 is also configured to demodulate data or other content received by the at least one antenna 1604. Each transceiver 1602 includes any suitable structure for generating signals for wireless or wired transmission or processing signals received wirelessly or by wire. Each antenna 1604 includes any suitable structure for transmitting or receiving wireless or wired signals. One or multiple transceivers 1602 could be used in the ED 1610, and one or multiple antennas 1604 could be used in the ED 1610. Although shown as a single functional unit, a transceiver 1602 could also be implemented using at least one transmitter and at least one separate receiver.

The ED 1610 further includes one or more input/output devices 1606 or interfaces (such as a wired interface to the Internet 1550). The input/output devices 1606 facilitate interaction with a user or other devices (network communications) in the network. Each input/output device 1606 includes any suitable structure for providing information to or receiving information from a user, such as a speaker, microphone, keypad, keyboard, display, or touch screen, including network interface communications.

In addition, the ED 1610 includes at least one memory 1608. The memory 1608 stores instructions and data used, generated, or collected by the ED 1610. For example, the memory 1608 could store software or firmware instructions executed by the processing unit(s) 1600 and data used to reduce or eliminate interference in incoming signals. Each memory 1608 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 16B, the base station 1670 includes at least one processing unit 1650, at least one transceiver 1652, which includes functionality for a transmitter and a receiver, one or more antennas 1656, at least one memory 1658, and one or more input/output devices or interfaces 1666. A scheduler, which would be understood by one skilled in the art, is coupled to the processing unit 1650. The scheduler could be included within or operated separately from the base station 1670. The processing unit 1650 implements various processing operations of the base station 1670, such as signal coding, data processing, power control, input/output processing, or any other functionality. The processing unit 1650 can also support the methods and teachings described in more detail above. Each processing unit 1650 includes any suitable processing or computing device configured to perform one or more operations. Each processing unit 1650 could, for example, include a microprocessor, microcontroller, digital signal processor, field programmable gate array, or application specific integrated circuit.

Each transceiver 1652 includes any suitable structure for generating signals for wireless or wired transmission to one or more EDs or other devices. Each transceiver 1652 further includes any suitable structure for processing signals received wirelessly or by wire from one or more EDs or other devices. Although shown combined as a transceiver 1652, a transmitter and a receiver could be separate components. Each antenna 1656 includes any suitable structure for transmitting or receiving wireless or wired signals. While a common antenna 1656 is shown here as being coupled to the transceiver 1652, one or more antennas 1656 could be coupled to the transceiver(s) 1652, allowing separate antennas 1656 to be coupled to the transmitter and the receiver if equipped as separate components. Each memory 1658 includes any suitable volatile or non-volatile storage and retrieval device(s). Each input/output device 1666 facilitates interaction with a user or other devices (network communications) in the network. Each input/output device 1666 includes any suitable structure for providing information to or receiving/providing information from a user, including network interface communications.

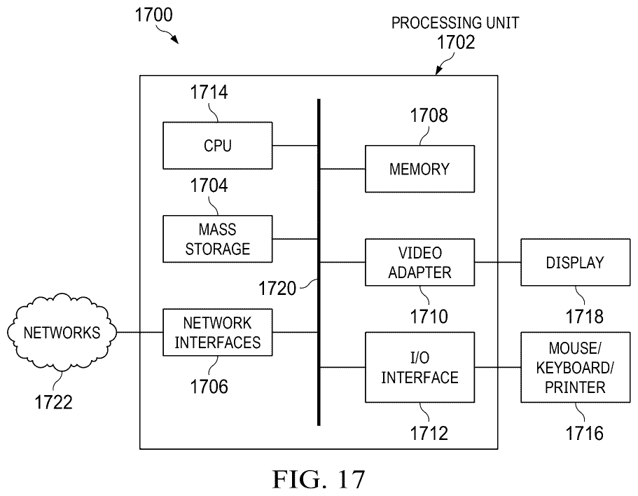

FIG. 17 is a block diagram of a computing system 1700 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1700 includes a processing unit 1702. The processing unit includes a central processing unit (CPU) 1714, memory 1708, and may further include a mass storage device 1704, a video adapter 1710, and an I/O interface 1712 connected to a bus 1720.

The bus 1720 may be one or more of any type of several bus architectures including a memory bus or memory controller, a peripheral bus, or a video bus. The CPU 1714 may comprise any type of electronic data processor. The memory 1708 may comprise any type of non-transitory system memory such as static random access memory (SRAM), dynamic random access memory (DRAM), synchronous DRAM (SDRAM), read-only memory (ROM), or a combination thereof. In an embodiment, the memory 1708 may include ROM for use at boot-up, and DRAM for program and data storage for use while executing programs.

The mass storage 1704 may comprise any type of non-transitory storage device configured to store data, programs, and other information and to make the data, programs, and other information accessible via the bus 1720. The mass storage 1704 may comprise, for example, one or more of a solid state drive, hard disk drive, a magnetic disk drive, or an optical disk drive.

The video adapter 1710 and the I/O interface 1712 provide interfaces to couple external input and output devices to the processing unit 1702. As illustrated, examples of input and output devices include a display 1718 coupled to the video adapter 1710 and a mouse, keyboard, or printer 1716 coupled to the I/O interface 1712. Other devices may be coupled to the processing unit 1702, and additional or fewer interface cards may be utilized. For example, a serial interface such as Universal Serial Bus (USB) (not shown) may be used to provide an interface for an external device.

The processing unit 1702 also includes one or more network interfaces 1706, which may comprise wired links, such as an Ethernet cable, or wireless links to access nodes or different networks. The network interfaces 1706 allow the processing unit 1702 to communicate with remote units via the networks. For example, the network interfaces 1706 may provide wireless communication via one or more transmitters/transmit antennas and one or more receivers/receive antennas. In an embodiment, the processing unit 1702 is coupled to a local-area network 1722 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A method, comprising:
obtaining, by an apparatus, a protocol data unit (PDU) of a data stream;
determining, by the apparatus, whether the PDU satisfies one or more conditions; and
transmitting, by the apparatus, the PDU in accordance with a first manner in response to determining that the PDU satisfies the one or more conditions, or in accordance with a second manner in response to determining that the PDU does not satisfy the one or more conditions, the second manner being different from the first manner in which one or more bearers among established multiple bearers are utilized in the transmitting.

2. The method of claim 1, further comprising:
classifying, by the apparatus, the PDU as a first type or a second type based on a result of the determining whether the PDU satisfies the one or more conditions, the first type corresponding to satisfying the one or more conditions, and the second type corresponding to not satisfying the one or more conditions,
wherein the transmitting the PDU in accordance with the first manner is in response to classifying the PDU as the first type, and
wherein the transmitting the PDU in accordance with the second manner is in response to classifying the PDU as the second type.

3. The method of claim 1, wherein the apparatus is or is part of a user equipment (UE), the obtaining the PDU comprising:
obtaining, by the apparatus, the PDU from an upper layer of the UE,
the transmitting the PDU comprising:
transmitting, by the apparatus, the PDU to a base station serving the UE.

4. The method of claim 1, wherein the apparatus is or is part of a base station, the obtaining the PDU comprising:
receiving, by the apparatus, the PDU from a core network node,
the transmitting the PDU comprising:
transmitting, by the apparatus, the PDU to a UE served by the base station.

5. The method of claim 1, further comprising:
obtaining, by the apparatus, configuration about the one or more conditions associated with the PDU of the data stream, the determining whether the PDU satisfies the one or more conditions comprising:
determining, by the apparatus, whether the PDU satisfies the one or more conditions in accordance with the configuration.

6. The method of claim 5, the configuration indicating a PDU Set size threshold, the method further comprising:
obtaining, by the apparatus, a total number of all PDUs in a PDU Set that the PDU belongs to, the determining whether the PDU satisfies the one or more conditions comprising:
determining, by the apparatus, that the PDU satisfies the one or more conditions in response to the total number being greater than the PDU Set size threshold; or
determining, by the apparatus, that the PDU does not satisfy the one or more conditions in response to the total number being less than the PDU Set size threshold.

7. The method of claim 5, the configuration indicating at least a first set of PDU Set importance values and a second set of PDU Set importance values, the first set of PDU Set importance values corresponding to satisfying the one or more conditions and the second set of PDU Set importance values corresponding to not satisfying the one or more conditions, the method further comprising:
obtaining, by the apparatus, a PDU Set importance value of a PDU Set that the PDU belongs to, the determining whether the PDU satisfies the one or more conditions comprising:
determining, by the apparatus, that the PDU satisfies the one or more conditions in response to the PDU Set importance value being among the first set of PDU Set importance values; or
determining, by the apparatus, that the PDU does not satisfy the one or more conditions in response to the PDU Set importance value being among the second set of PDU Set importance values.

8. The method of claim 5, the configuration indicating a time threshold, the method further comprising:
obtaining, by the apparatus, a remaining time until a delivery deadline associated with the PDU, the determining whether the PDU satisfies the one or more conditions comprising:
determining, by the apparatus, that the PDU satisfies the one or more conditions in response to the remaining time being less than the time threshold; or
determining, by the apparatus, that the PDU does not satisfy the one or more conditions in response to the remaining time being greater than the time threshold.

9. The method of claim 5, the configuration indicating at least a first set of media data unit (MDU) type values and a second set of MDU type values, the first set of MDU type values corresponding to satisfying the one or more conditions and the second set of MDU type values corresponding to not satisfying the one or more conditions, the method further comprising:
obtaining, by the apparatus, an MDU type value of an MDU carried by a PDU Set that the PDU belongs to, the determining whether the PDU satisfies the one or more conditions comprising:
determining, by the apparatus, that the PDU satisfies the one or more conditions in response to the MDU type value being among the first set of MDU type values; or
determining, by the apparatus, that the PDU does not satisfy the one or more conditions in response to the MDU type value being among the second set of MDU type values.

10. The method of claim 5, the configuration indicating at least a first set of inter-dependency indication values and a second set of inter-dependency indication values, the first set of inter-dependency indication values corresponding to satisfying the one or more conditions and the second set of inter-dependency indication values corresponding to not satisfying the one or more conditions, the method further comprising:
obtaining, by the apparatus, an inter-dependency indication value of a PDU Set that the PDU belongs to, the determining whether the PDU satisfies the one or more conditions comprising:
determining, by the apparatus, that the PDU satisfies the one or more conditions in response to the inter-dependency indication value being among the first set of inter-dependency indication values; or
determining, by the apparatus, that the PDU does not satisfy the one or more conditions in response to the inter-dependency indication value being among the second set of inter-dependency indication values.

11. The method of claim 5, the configuration indicating at least a first set of discardable indication values and a second set of discardable indication values, the first set of discardable indication values corresponding to satisfying the one or more conditions and the second set of discardable indication values corresponding to not satisfying the one or more conditions, the method further comprising:
obtaining, by the apparatus, a discardable indication value of a PDU Set that the PDU belongs to, the determining whether the PDU satisfies the one or more conditions comprising:
determining, by the apparatus, that the PDU satisfies the one or more conditions in response to the discardable indication value being among the first set of discardable indication values; or
determining, by the apparatus, that the PDU does not satisfy the one or more conditions in response to the discardable indication value being among the second set of discardable indication values.

12. The method of claim 1, the established multiple bearers being multiple radio link control (RLC) bearers, and the determining whether the PDU satisfies the one or more conditions being performed by a packet data convergence protocol (PDCP) entity of the apparatus.

13. The method of claim 12,
wherein the transmitting in the first manner comprises:
submitting, by the apparatus, the PDU to a first RLC entity configured for a first RLC bearer among the multiple RLC bearers, and
wherein the transmitting in the second manner comprises:
submitting, by the apparatus, the PDU to a second RLC entity configured for a second RLC bearer among the multiple RLC bearers, the first RLC bearer being configured to be more reliable than the second RLC bearer.

14. The method of claim 13, wherein the first RLC entity is configured to operate in an RLC acknowledged mode (AM), and the second RLC entity is configured to operate in an RLC unacknowledged mode (UM).

15. The method of claim 13, wherein the first RLC entity is configured to operate in an RLC AM with a third number of RLC retransmissions maximally allowed, and the second RLC entity is configured to operate in the RLC AM with a fourth number of RLC retransmissions maximally allowed, the third number being greater than the fourth number.

16. The method of claim 13, the method further comprising:
configuring, by the apparatus, a media access control (MAC) entity of the apparatus with a restriction, the MAC entity being associated with the first RLC bearer, the restriction prohibiting the MAC entity from assigning a transmission opportunity to a logical channel associated with the first RLC bearer, the transmission opportunity utilizing an unlicensed band.

17. The method of claim 12,
wherein the transmitting in the first manner comprises:
submitting, by the apparatus, the PDU to a first number of RLC entities respectively configured for a first number of RLC bearers among the multiple RLC bearers, and
wherein the transmitting in the second manner comprises:
submitting, by the apparatus, the PDU to a second number of RLC entities respectively configured for a second number of RLC bearers among the multiple RLC bearers, the first number being greater than the second number.

18. The method of claim 17, wherein the transmitting in the first manner further comprises:
using, by the apparatus, PDCP duplication to duplicate the PDU for the submitting to the first number of RLC bearers.

19. The method of claim 1, the established multiple bearers being multiple data radio bearers (DRBs), wherein the transmitting in the first manner comprises:
submitting, by the apparatus, the PDU to a first PDCP entity of the apparatus, the first PDCP entity being configured for a first DRB among the multiple DRBs, and
wherein the transmitting in the second manner comprises:
submitting, by the apparatus, the PDU to a second PDCP entity of the apparatus, the second PDCP entity being configured for a second DRB among the multiple DRBs, the first DRB being configured to be more reliable than the second DRB.

20. An apparatus comprising:
at least one processor; and
a non-transitory computer readable storage medium storing programming, the programming including instructions that, when executed by the at least one processor, cause the apparatus to perform:
obtaining a protocol data unit (PDU) of a data stream;
determining whether the PDU satisfies one or more conditions; and
transmitting the PDU in accordance with a first manner in response to determining that the PDU satisfies the one or more conditions, or in accordance with a second manner in response to determining that the PDU does not satisfy the one or more conditions, the second manner being different from the first manner in which one or more bearers among established multiple bearers are utilized in the transmitting.

21. A non-transitory computer-readable medium having instructions stored thereon that, when executed by an apparatus, cause the apparatus to perform:
obtaining a protocol data unit (PDU) of a data stream;
determining whether the PDU satisfies one or more conditions; and
transmitting the PDU in accordance with a first manner in response to determining that the PDU satisfies the one or more conditions, or in accordance with a second manner in response to determining that the PDU does not satisfy the one or more conditions, the second manner being different from the first manner in which one or more bearers among established multiple bearers are utilized in the transmitting.
